(19) United States
(12) Patent Application Publication
(10) Pub. No.: US 2026/0053294 A1
(43) Pub. Date: Feb. 26, 2026

(54) COATING COMPOSITIONS INCLUDING ACRYLIC POLYMERS FOR COOKWARE, BAKEWARE AND OTHER COOKING APPLIANCES

(71) Applicant: PPG Industries Ohio, Inc., Cleveland, OH (US)

(72) Inventors: Venkateshwarlu Kalsani, Prospect, PA (US); Peter Richard Jepson, Exton, PA (US); Thomas James Bate, Glenview, IL (US); James Harrison Lettow, Pittsburgh, PA (US)

(73) Assignee: PPG Industries Ohio, Inc., Cleveland, OH (US)

(21) Appl. No.: 19/103,020

(22) PCT Filed: Aug. 14, 2023
(86) PCT No.: PCT/US2023/072136

§ 371 Date: Feb. 11, 2025

Related U.S. Application Data
(60) Provisional application No. 63/371,428, filed on Aug. 15, 2022.

(51) Int. Cl. A47J 36/04; A47J 36/02; C09D 5/02; C09D 5/16; C09D 5/18; C09D 7/63; C09D 133/06; C09D 183/04

(52) U.S. Cl. CPC A47J 36/04; A47J 36/025; C09D 5/022; C09D 5/024; C09D 5/1668; C09D 5/1675; C09D 5/18; C09D 7/63; C09D 133/064; C09D 183/04

(57) ABSTRACT

Coating compositions that may form flexible, heat resistant coatings on substrates such as cookware, bakeware, or other cooking appliances are derived from and/or include an acid rich acrylic polymer. The coating compositions may be water borne or solvent borne and may be produced or formulated via a plurality of pathways.

### FIELD

The present disclosure relates to coating compositions including acrylic polymers for cookware, bakeware or other cooking appliances, wherein the coatings formed from the compositions demonstrate flexibility and heat resistance. The coating compositions may be applied to an interior, or food contact, surface and/or to a non-food contact surface of an article of cookware, bakeware or other cooking appliance.

### BACKGROUND

Heat resistant coatings are commonly applied to substrates such as cookware, bakeware, cooking appliances such as grills, and other substrates to provide functions such as aiding in heat transfer, providing a non-stick release surface, and/or providing a decorative color or aesthetic finish.

Currently, the cookware and bakeware industry rely on both fluorine and silicone-based polymer coating technologies to provide non-stick and easy to clean properties to metal surfaces as well as to withstand elevated cooking temperatures up to 260° C., for example. The strength of the covalent carbon-fluorine (C—F) bond results in polymers that are resistant to both chemical attack and thermal degradation. When considering the complete life cycle of the material, the strength of the C—F bond, while beneficial in many applications including non-stick cookware coatings, has become subject to increased regulatory scrutiny in connection with per- and polyfluoro-alkyl substances (PFAS).

What is desired are coating compositions which are an improvement on the foregoing.

### SUMMARY

The present disclosure provides a coating composition including an acrylic emulsion including particles formed of first and second polymers, a filler material present in an amount of at least 2 wt. % based on the total weight of the coating composition, and water. The first polymer is polymerized from ethylenically unsaturated monomers including an acid containing monomer. The second polymer is chemically different from the first polymer. The second polymer is polymerized from ethylenically unsaturated monomers including a linking monomer. The first and second polymer having at least one of crosslinking covalent linkages and non-covalent interactions between the acid containing monomer of the first polymer and the linking monomer of the second polymer.

The present disclosure further provides a method of coating a substrate with a coating composition including applying, to the surface of the substrate, a coating composition including an acrylic emulsion including particles formed of first and second polymers, a filler material present in an amount of at least 2 wt. % based on the total weight of the coating composition, and water; and curing the coating composition to form a coating. Additionally, the present disclosure provides an article coated according to the method above, the article selected from an article of cookware, an article of bakeware, and a cooking appliance.

The present disclosure also provides an acrylic emulsion composition including an aqueous medium; a neutralizing agent; and emulsion particles. The emulsion particles include a film-forming resin comprising a siloxane polymer; and an acrylic polymer polymerized from ethylenically unsaturated monomers including an acid containing monomer. The film-forming resin is emulsified by the acrylic polymer within the aqueous medium.

The present disclosure further provides a method of coating a substrate with a coating composition including applying, to the surface of the substrate, a coating composition comprising an acrylic emulsion composition including an aqueous medium; a neutralizing agent; and emulsion particles; and curing the coating composition to form a coating. Additionally, the present disclosure provides an article coated according to the method above, the article selected from an article of cookware, an article of bakeware, and a cooking appliance.

The present disclosure also provides a coating composition including a solvent medium; a film-forming resin, the film forming resin comprising a siloxane polymer; and an acrylic polymer polymerized from ethylenically unsaturated monomers include an acid containing monomer. The ethylenically unsaturated monomers have a content of acid containing monomers from 20 wt. % to 70 wt. % based on a total weight of the ethylenically unsaturated monomers.

The present disclosure further provides a method of coating a substrate with a coating composition including applying to the surface of the substrate, a coating composition including a solvent medium; a film-forming resin, the film forming resin comprising a siloxane polymer; and an acrylic polymer polymerized from ethylenically unsaturated monomers include an acid containing monomer; and curing the coating composition to form a coating. Additionally, the present disclosure provides an article coated according to the method above, the article selected from an article of cookware, an article of bakeware, and a cooking appliance.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings. These above-mentioned and other features of the disclosure may be used in any combination or permutation.

FIG. 1 illustrates a flow chart of four exemplary pathways for producing coating compositions in accordance with the present disclosure;

FIG. 2A illustrates a substrate coated with a coating composition of the present disclosure;

FIG. 2B illustrates a cross section of the substrate of FIG. 2A; and

FIG. 3 illustrates a particle size reduction to determine the wt. % acrylic emulsifier on film forming resin needed to achieve and stabilize the median for a volume distribution (D50) in the formation of the silicone acrylic emulsion.

Corresponding reference characters indicate corresponding parts throughout the several views. The exemplifications set out herein illustrate the disclosure, and such exemplifications are not to be construed as limiting the scope of the disclosure in any manner.

### DETAILED DESCRIPTION

The present disclosure provides coating compositions that may be applied to an interior, or food-contact, surface and/or to an exterior, or heat-contact, surface of an article of cookware or bakeware. Further, the present disclosure provides coating compositions that may be formulated either as aqueous or water-based compositions or as solvent borne compositions for application to cookware, bakeware or other cooking appliances to form non-stick coatings with good release properties that are heat resistant, yet flexible.

### I. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Whereas particular examples of this disclosure have been described above for purposes of illustration, it will be evident to those skilled in the art that numerous variations of the details of the present disclosure may be made without departing from what is defined in the appended claims.

Also, it should be understood that any numerical range recited herein is intended to include all sub-ranges subsumed therein. For example, a range of “1 to 10” is intended to include all sub-ranges from (and including) the recited minimum value of 1 to the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

The use of the term “non-stick” herein is intended to mean a coating having release properties, particularly when the coating is applied to articles of cookware and/or bakeware. When the coating is applied to articles of cookware and/or bakeware, non-stick may pertain to food release properties, including food fouling release properties.

“Core-shell polymer” is used herein based on the theory that in forming the latex particles of the present disclosure, one stage of polymerization results in the formation of a polymeric surfactant which becomes located in an outer or shell region of the final particle, and another stage of polymerization results in the formation of a core on the inside of the shell. Although there is evidence that this “core-shell” morphology does in fact exist, its existence is not essential to the functioning of the present disclosure.

“Shell” relates to the polymeric surfactant which becomes located in an outer or shell region of the final particle formed during polymerization.

“Core” relates to the core formed inside the shell during polymerization.

“Wet” coating composition as used herein refers to a liquid, or uncured coating composition which includes water and/or volatile components.

“Dry” coating composition as used herein refers to a cured coating composition which essentially lacks water and/or volatile components.

“Substrate” and “article” as used herein refers to an object or other item with a surface onto which a coating composition may be applied.

“Solids” refers to the non-volatile components present in a composition of volatile and non-volatile components. As used herein, a weight percentage based on “solids” refers to an amount of a component based on a total weight of the pre-condensed silicone resin.

“Resin solids” refers to the solid components that make up the binder or film-forming components of the composition. As used herein, a weight percentage based on “resin solids” refers to an amount of a component based on a total weight of the binder or film-forming components of a composition.

“Siloxane monomer” and “siloxane polymer” refer to a monomer or polymer, respectively, containing alternating silicon-oxygen linkages, e.g., O—Si—O and/or Si—O—Si linkages.

“Emulsion” refers to a fine dispersion of one liquid within another liquid. As used herein, a “silicone resin coating emulsion” refers to an emulsion comprising silicone resin coating composition dispersed into a solvent. As used herein, an “emulsion solution” refers to a diluted emulsion comprising silicone resin coating composition dispersed into a solvent.

“Waterborne” refers to a composition formulated with, and including, predominantly one or more aqueous solvents. As discussed herein, waterborne compositions may have a VOC level of less than 420 g/L.

“Solventborne” refers to a composition formulated with, and including, predominantly one or more non-aqueous solvents. As discussed herein, solventborne compositions may have a VOC level of greater than 420 g/L.

### II. Coating Compositions

The coating compositions of the present disclosure may form flexible, heat resistant coatings, and are derived from and/or include an acrylic polymer. The acrylic polymer may be acid rich, meaning that the polymer, as discussed herein, is formed from a relatively high percentage of acid containing monomers based on the total weight of the polymer. The coating compositions may be solvent borne or, alternatively, aqueous or water borne, and the coating compositions may be produced or formulated via a plurality of reaction pathways.

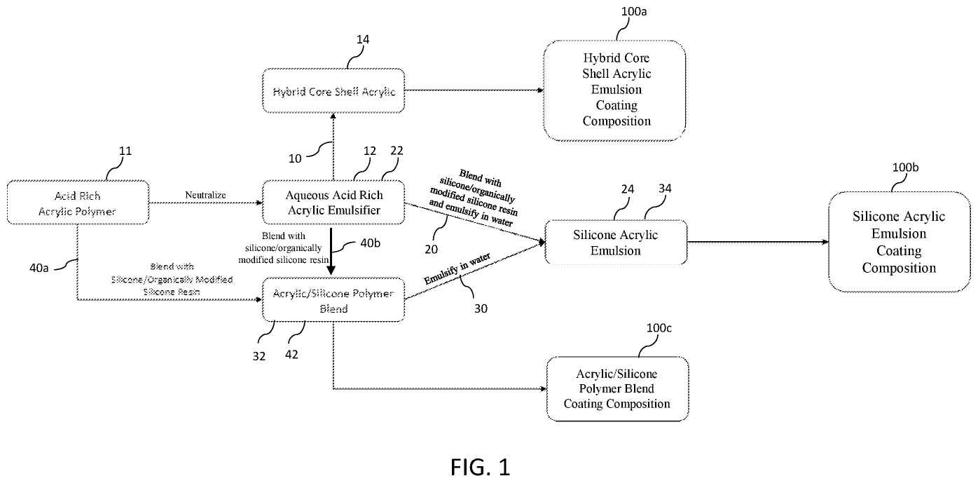

As shown in FIG. 1, four exemplary pathways for forming coating compositions in accordance with the present disclosure include a first pathway 10, a second pathway 20, and a third pathway 30 to formulate water borne coating compositions, and/or a fourth pathway 40 to formulate solvent borne coating compositions.

Each of the coating compositions may comprise an acid rich acrylic polymer which, as described further below, may be neutralized, and/or may be blended with another polymer/resin, such as a siloxane polymer/resin, for example.

The acid rich acrylic polymer may be formed by free radical polymerization wherein ethylenically unsaturated monomers are polymerized. The acid rich acrylic resin can be neutralized to form an acid rich acrylic emulsifier, or emulsifier, and may be used to emulsify a film forming resin in an aqueous medium, and the emulsified film forming resins may be formulated into coating compositions.

### A. Acid Rich Acrylic Polymer

The acid rich acrylic polymer may be formed from a first mixture of monomer components that undergo a polymerization reaction. The monomers may be ethylenically unsaturated monomers selected to yield a polymer having an excess of acid functionality to render the polymer particles stable in an aqueous medium when neutralized with a base.

The first monomer mixture may comprise monomers of exemplary Formulas (I), (II), and (III):

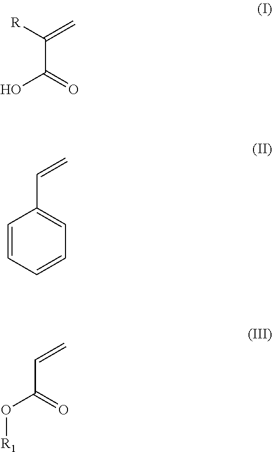

wherein R is a H or alkyl group, and R₁ is an alkyl, aryl, or silyl group.

The monomer mixture may have a weight percent of acid group containing monomers from 10 wt. %, 15 wt. %, or 30 wt. % to 40 wt. %, 60 wt. %, or 90 wt. %, or within any range using any two of the foregoing as end points, such as 10 wt. % to 90 wt. %, 15 wt. % to 60 wt. %, or 30 wt. % to 40 wt. %, based on a total weight of the monomers.

Attaining the desired combination of coating application and performance at these high acid levels was attained by the use of at least one acid group containing monomer. Among suitable acid group containing monomers employed in the first polymerization may be acrylic acid and methacrylic acid which, when used either along or together in combination, may be in a weight ratio from 1:10 to 10:1, 1:3 to 3:1, or 2:3 to 3:2, or within any range using any two of the foregoing as end points. Other suitable acid monomers may include itaconic acid, maleic acid, fumaric acid, phosphatized acrylate/methacrylates, and sulfonate acrylate/methacrylates.

The resulting acrylic polymer may have an acid value from 10 mg KOH, 50 mg KOH, 70 mg KOH, 90 mg KOH, 100 mg KOH, 120 mg KOH, or 125 mg KOH to 150 mg KOH, 200 mg KOH, 300 mg KOH, 400 mg KOH, 500 mg KOH, 600 mg KOH, or 700 mg KOH, or within any range using any two of the foregoing as end points, such as 10 to 700 mg KOH, 50 to 600 mg KOH, 70 to 500 mg KOH, 90 to 400 mg KOH, 100 to 300 mg KOH, 120 to 200 mg KOH, or 125 to 150 mg KOH, wherein acid value may be determined using a Metrohm 798 MPT Titrino automatic titrator, manufactured by Metrohm AG, according to ASTM D4662-15 (2020).

In addition to the acid group containing monomer, the first monomer mixture may include alkyl acrylates (such as methyl, ethyl, propyl, or butyl acrylate) or the corresponding methacrylates, including mixtures thereof. It is also possible to use as comonomers in the first stage polymerization higher molecular weight acrylic monomers such as 2-ethylhexyl acrylate, cyclohexyl acrylate, n-hexyl acrylate, lauryl acrylate, tridecyl acrylate, isobornyl acrylate, stearyl acrylate, n-decyl methacrylate, benzyl acrylate, isobutyl acrylate, dicyclopentyl acrylate, isodecyl acrylate, tertiary butyl acrylate, palmitic acrylate, ethoxy ethyl acrylate, methoxy butyl acrylate, 2-(2-ethoxy ethoxy) ethyl acrylate, 2-phenoxyethyl acrylate, tetrahydrofurfuryl acrylate, methoxylated tripropylene glycol monoacrylate, 1H-, 1H-,5H-octafluoropentyl acrylate, trimethylsiloxyethyl acrylate, or the corresponding methacrylates of the foregoing.

The first monomer mixture may have a weight percent of optional acrylate monomers from 0 wt. %, 5 wt. %, 10 wt. %, 15 wt. %, or 20 wt. %, to 25 wt. %, 30 wt. %, 35 wt. %, or 40 wt. %, or within any range using any two of the foregoing as end points, such as 0 wt. % to 40 wt. %, 5 wt. % to 35 wt. %, 10 wt. % to 30 wt. %, or 20 wt. % to 25 wt. %, where the wt. % is based on the total weight of the first monomer mixture.

Optionally included in the first monomer mixture are one or more non-acrylate monomers having alpha-beta ethylenic unsaturation. These additional non-acrylate monomers may serve as diluents to reduce the cost of the latex, or as modifiers to refine the properties of the polymers. Non-acrylate monomers may include styrene, ethylstyrene, vinyl esters, 1,4-butadiene, acrylonitrile, vinyl ethers, acrylamides, fumarate esters, and the like.

The first monomer mixture may have a weight percent of optional non-acrylate monomers from 0 wt. %, 5 wt. %, 10 wt. %, 15 wt. %, or 20 wt. %, to 25 wt. %, 30 wt. %, 35 wt. %, 40 wt. %, 45 wt. %, 50 wt. %, 55 wt. %, or 60 wt. %, or within any range using any two of the foregoing as end points, such as 0 wt. % to 60 wt. %, 5 wt. % to 55 wt. %, 10 wt. % to 50 wt. %, 15 wt. % to 45 wt. %, 20 wt. % to 40 wt. %, or 25 wt. % to 35 wt. %, where the wt. % is based on the total weight of the first monomer mixture.

The polymerization to form the acid acrylic polymer may occur in the absence of chain transfer agents. Chain transfer agents are compounds used to control the chain length during synthesis to achieve certain mechanical and processing properties. By an absence of chain transfer agents it is meant that the polymerization occurs in the presence of less than 0.1 wt. % of chain transfer agents, wherein the weight percent is defined by the total weight of the reactants of the polymerization reaction.

The resulting acid rich acrylic polymer may be a polymer represented by exemplary Formula (IV):

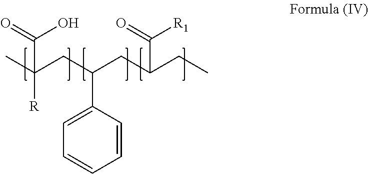

wherein R is a H or alkyl group, and R₁ is an alkyl, aryl, or silyl group.

As shown in FIG. 1 and discussed further below, the acid acrylic polymer 11 may be used to form water borne coating compositions or solvent borne coating compositions.

The coating compositions provided by the present disclosure may comprise a weight percentage of acrylic polymer from 2 wt. %, 4 wt. %, or 8 wt. % to 12 wt. %, 15 wt. %, or 20 wt. %, or within any range using any two of the foregoing as endpoints, such as 2 wt. % to 20 wt. %, 4 wt. % to 15 wt. %, 8 wt. % to 10 wt. %, where wt. % is based on the total weight of the coating composition (“wet” weight).

The coating compositions provided by the present disclosure may comprise a weight percentage of acrylic polymer from 2 wt. %, 4 wt. %, or 6 wt. % to 8 wt. %, 12 wt. %, or 15 wt. %, or within any range using any two of the foregoing as endpoints, such as 2 wt. % to 15 wt. %, 4 wt. % to 12 wt. %, 6 wt. % to 8 wt. %, where wt. % is based on the total weight of the solids components of the coating composition (“dry” weight).

i. Water Borne Coating Compositions

A water borne coating 100a, 100b may be formulated using a variety of different components. As shown in FIG. 1, pathways 10, 20, and 30 may all create a water borne coating composition 100a, 100b.

a. First Pathway 10

As exemplified via pathway 10 of FIG. 1, the acid acrylic polymer 11 may be neutralized to create an aqueous acid rich acrylic emulsifier 12, wherein the acrylic emulsifier 12 may alternatively be referred to as an acid rich an acrylic soap. The acrylic emulsifier 12 may be a core polymer formed by partially neutralizing the acid groups of the acrylic polymer 11 with an appropriate basic compound. Suitable basic compounds may include organic bases and inorganic bases. Bases that may be used for neutralization include alkali metal hydroxides, ammonia, ammonium hydroxide, methylethanolamine, and diethanolamine. The minimum extent to which the acid groups must be neutralized in order to provide stability to the latex can be readily determined by those of skill in the art for a particular composition. Suitable neutralizing agents may include amines, such as dimethylethanolamine, ammonia, triethanolamine, dimethylethyl ethanolamine or N′,N′-dimethyl aminopropylamine or alkali metal salts such as sodium or potassium hydroxide.

The resulting acid acrylic emulsifier 12 may be represented by exemplary Formula (V):

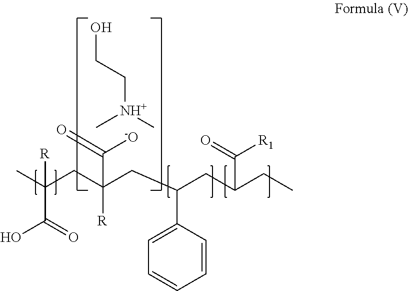

wherein R is a H or alkyl group, and R₁ is an alkyl, aryl, or silyl group.

The acid acrylic emulsifier 12 may then undergo polymerization with a second mixture of monomers to create a film forming resin. The film forming resin may be a hybrid core shell acrylic 14.

The monomer components of the second monomer mixture used in the polymerization of the acrylic emulsifier to form the core of the latex particles may be selected from a wide variety of ethylenically unsaturated monomers, including the optional acrylate and non-acrylate unsaturated monomers discussed above in connection with the first monomer mixture, or a combination of both. Small acrylates, i.e., those having less than three carbon atoms in the side chain may be used. Acrylates having four or more carbon atoms in the side chain, such as butyl acrylate, may be included in minor amounts, such as less than 10 percent by weight of the second monomer mixture. Non-acrylate unsaturated monomers may be included as diluents and modifiers as described above in connection with the polymerization of the acrylic polymer.

Suitable monomers in the second monomer mixture may be of exemplary Formulas (VI), (VII), (VIII), and (IX):

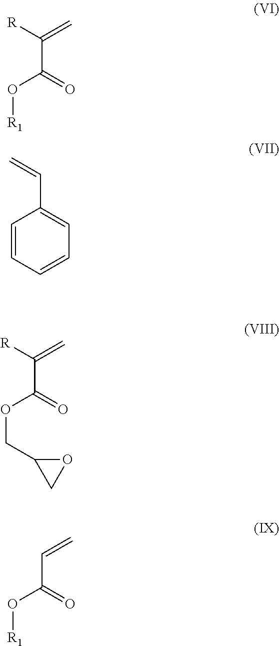

wherein R is a H or alkyl group, and R₁ is an alkyl, aryl, or silyl group.

The second monomer mixture used in the polymerization of the acid acrylic emulsifier core polymer may have a weight percent of optional acrylate monomers from 30 wt. %, 40 wt. %, or 50 wt. %, to 70 wt. %, 80 wt. %, or 90 wt. %, or within any range using any two of the foregoing as end points, such as 30 wt. % to 90 wt. %, 40 wt. % to 80 wt. %, or 50 wt. % to 70 wt. %, where the wt. % is based on the total weight of the second monomer mixture.

The second monomer mixture may have a weight percent of optional non-acylate unsaturated monomers from 0 wt. %, 10 wt. %, 20 wt. %, 30 wt. %, or 35 wt. %, to 60 wt. %, 70 wt. %, 80 wt. %, or 90 wt. %, or within any range using any two of the foregoing as end points, such as 0 wt. % to 90 wt. %, 10 wt. % to 80 wt. %, 20 wt. % to 70 wt. %, 30 wt. % to 60 wt. %, or 40 wt. % to 50 wt. %, where the wt. % is based on the total weight of the second monomer mixture.

Monomers for the second polymerization may also include a hydroxy group containing monomer, which is useful for providing crosslinking functionality in the polymeric product. The hydroxy group containing monomer may be a hydroxy functional acrylate such as hydroxyethyl acrylate, hydroxypropyl acrylate, 2-hydroxybutyl acrylate, 4-hydroxybutyl acrylate, acrylate esters of polyethylene glycols, acrylate esters of polypropylene glycols, glycerol monoacrylate, and the like, and the corresponding methacrylates of the foregoing. The hydroxy group containing monomer may be included in the second monomer mixture in amounts ranging from 0 to 10 percent by weight.

No acid group containing monomers need be included in the second stage since the core is relatively hydrophobic, but a small amount of acid functionality may be present. A small amount of acid in the core is sometimes considered advantageous in carrying out the polymerization process. The acid group containing monomer may be selected from any of those used in the shell. Acid group containing monomers may be present in the second monomer mixture in an amount from 0 wt. %, 2 wt. %, or 4 wt. % to 6 wt. %, 8 wt. %, or 10 wt. %, or within any range using any two of the foregoing as end points, such as 0 wt. % to 10 wt. %, 2 wt. % to 8 wt. %, or 4 wt. % to 6 wt. %, based on a total weight of the monomers in the second monomer mixture.

The acid acrylic emulsifier 12 may be polymerized to create the hybrid core shell acrylic 14 in the absence of chain transfer agents. Chain transfer agents are compounds used to control the chain length during synthesis to achieve certain mechanical and processing properties.

Optionally, the core 12, the shell 11, or both may be crosslinked. Particularly advantageous is the inclusion in the core of a combination of an unsaturated epoxy compound and a multi-functional vinyl compound. Multi-functional vinyl crosslinking monomers, or “linking monomers,” may include allyl methacrylate, ethylene glycol dimethacrylate, trimethylolpropane triacrylate, triallyl cyanurate and the like to the monomer feeds. The multi-functional vinyl linking monomers may be included in the second monomer mixture in amounts from 0 wt. %, 0.1 wt. %, or 1 wt. % to 4 wt. %, 6 wt. %, or 8 wt. %, or within any range using any two of the foregoing as end points, such as 0 wt. % to 8 wt. %, 0.1 wt. % to 6 wt. %, or 1 wt. % to 4 wt. %, based on a total weight of the monomers in the second monomer mixture. Unsaturated epoxy linking monomers may include glycidyl acrylate, glycidyl methacrylate, and allyl glycidyl ether.

The second monomer mixture may have a weight percent of unsaturated epoxy linking monomers from 0 wt. %, 0.5 wt. %, 1 wt. %, 1.5 wt. %, or 2 wt. %, to 2.5 wt. %, 3 wt. %, 3.5 wt. %, 4 wt. %, 4.5 wt. %, 5 wt. %, 6 wt. %, 7 wt. %, or 8 wt. %, or within any range using any two of the foregoing as end points, such as 0 wt. % to 8 wt. %, 0.5 wt. % to 7 wt. %, 1 wt. % to 6 wt. %, 1.5 wt. % to 5 wt. %, 2 wt. % to 4.5 wt. %, 2.5 wt. % to 4 wt. %, or 3 wt. % to 3.5 wt. %, where the wt. % is based on the total weight of the second monomer mixture. Co-reaction of acid groups with the epoxy groups results in a crosslinked particle.

The second monomer mixture may contain a second linking monomer type that may optionally be included, such as, alkoxy acrylamides including N-butoxy methyl acrylamide. The second monomer mixture may have a weight percent of a second linking monomer from 0 wt. %, 5 wt. %, or 10 wt. % to 15 wt. %, 20 wt. %, 25 wt. %, or 30 wt. %, or within any range using any two of the foregoing as end points, such as 0 wt. % to 30 wt. %, 5 wt. % to 25 wt. %, 10 wt. % to 20 wt. %, or 15 wt. % to 20 wt. %, where the wt. % is based on the total weight of the second monomer mixture.

Two or more polymers may be crosslinked together via chemical bonding such as via crosslinking covalent linkages between the epoxy functional monomer components of the first polymer and the acid functional monomer components of the shell and core polymers.

Alternatively, or in addition to the crosslinks formed by chemical bonding discussed above, the core and shell polymers may be linked via non-covalent interactions (non-chemically bonded) such as via van der Waals, dipole-dipole interactions, ionic interactions, or hydrogen bonding between the monomer components of the shell and core polymers.

The resulting film forming resin may be a hybrid acrylic core shell polymer 14 of exemplary Formula (X):

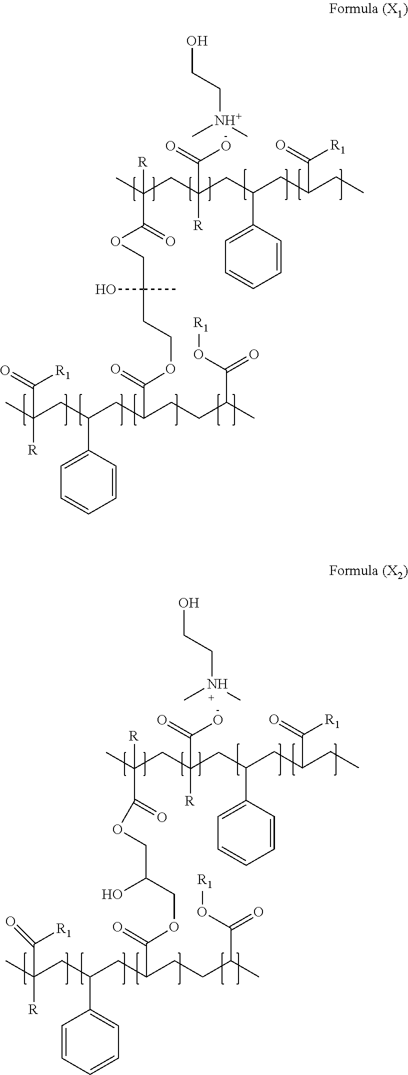

wherein R is a H or alkyl group, and R₁ is an alkyl, aryl, or silyl group.

In Formula (X₁), the dashed line represents that acid addition to the epoxy ring can be on either carbon of the epoxy ring, wherein the acid will typically add to the least sterically hindered epoxy carbon such that the actual resulting chemical structure of the hybrid core acrylic shell polymer 14 may be represented by Formula (X₂).

The hybrid acrylic core shell polymer 14 may be formulated into a hybrid core shell emulsion coating composition 100a by adding additives, as described below, such as filler, pigments, crosslinkers, and rheology modifiers. Coating 100a may be a flexible, heat resistance coating.

The coating composition may comprise the hybrid acrylic core shell polymer 14 in an amount from 0 wt. %, 1.0 wt. %, 1.5 wt. %, or 2 wt. %, to 2.5 wt. %, 3.0 wt. %, 3.8 wt. %, or 4.0 wt. %, or within any range using any two of the foregoing as endpoints, such as 1 wt. % to 4.0 wt. %, 1.0 wt. % to 3.8 wt. %, 1.5 wt. % to 3.0 wt. %, or 2.0 wt. % to 2.5 wt. %, where wt. % is based on the total weight of the coating composition (“wet” weight).

The coating composition provided by the present disclosure may comprise a weight percentage of the hybrid acrylic core shell polymer 14 from 0 wt. %, 1 wt. %, 10 wt. %, 15 wt. %, or 20 wt. %, to 25 wt. %, 30 wt. %, 35 wt. %, or 40 wt. %, or within any range using any two of the foregoing as endpoints, such as 1 wt. % to 40 wt. %, 10 wt. % to 35 wt. %, 15 wt. % to 30 wt. %, or 20 wt. % to 25 wt. %, where wt. % is based on the total weight of the solids components of the coating composition (“dry” weight).

b. Pathway 20

As shown via pathway 20 of FIG. 1, a silicone acrylic emulsion coating composition may be formed. The silicone acrylic emulsion coating composition may comprise an aqueous medium, a neutralizing agent, and emulsion particles. To form the emulsion particles, the acid acrylic polymer 11, discussed above, may be neutralized to create an aqueous acid acrylic emulsifier 22 in the manner also described in relation to the acid acrylic emulsifier 12 of pathway 10. The resulting acrylic emulsifier 22 may be blended with a film forming resin, which may be a siloxane polymer such as a silicone-modified organic hydrophobic polymer and emulsified in water to form an emulsion 24.

The silicone-modified polymer may be an organosiloxane-based solid polymer, such as a methyl silicone resin, phenyl silicone resin, or methyl-phenyl silicone resin, which are typically thermoset compositions capable of providing a range of mechanical characteristics, ranging from soft and rubbery to hard and brittle.

An organoalkoxysilane may be grafted onto a free hydroxy group of a polymer, such as a hydrophobic polymer. The hydrophobic polymer may have an acid value less than 20 mg KOH, less than 15 mg KOH, or less than 10 mg KOH, for example, wherein acid value may be determined using a Metrohm 798 MPT Titrino automatic titrator, manufactured by Metrohm AG, according to ASTM D4662-15 (2020).

Examples of suitable hydrophobic polymers include acrylic polymers, epoxy polymers, and polyurethane polymers, as well as polyester polymers, described in more detail below.

A silicone-containing polymer may be reacted with, or grafted onto, the hydrophobic polymer to provide a silicone-modified polymer.

Exemplary organoalkoxysilanes are of the following formula:

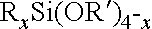

wherein R is one or more moieties chosen independently from linear, branched, or cyclic alkyl and aryl, including, for example, cyclohexyl and/or phenyl; R′ is methyl, ethyl, propyl or alkyl; and x is 0, 1, 2, or 3.

The degree of crosslinking may in turn be dependent upon the nature of the organosiloxane unit used in the composition. As shown in the table below, organosiloxanes may be described according to the degree of oxygen substitution, or functionality, on the central silicone.

TABLE 1
Organosiloxane Oxygen Substitution

| Structural formula | Functionality | Symbol |
|---|---|---|
| R₃Si—O— | Monofunctional | M |
| 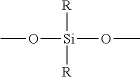 | Difunctional | D |
| 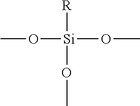 | Trifunctional | T |
| 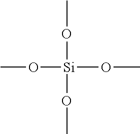 | Tetrafunctional | Q |

Generally, compositions including higher fractions of T (trifunctional) and Q (tetrafunctional) units display higher degrees of crosslinking.

In some examples, R is C6 aryl or a linear or branched alkyl having from as few as 1, 2, 3, or as many as 4, 5, 6, or more carbon atoms, or a number of carbon atoms in any other range combination using these endpoints. In an example, R is selected from methyl, ethyl, propyl, and phenyl. In some examples, x is at least 1 and less than 4.

In some examples, the organoalkoxysilane comprises at least one organoalkoxysilane selected from methyltrimethoxysilane, methyltriethoxysilane, dimethyldiethoxysilane, dimethyldimethoxysilane, trimethylmethoxysilane, trimethylethoxysilane, phenyltrimethoxysilane, phenyl triethoxysilane, cyclohexyltrimethoxy silane, or combinations of the foregoing.

In some examples, the organoalkoxysilane is a functionalized siloxane, such as 3-aminopropyltriethoxysilane, (3-glycidoxypropyl)trimethoxysilane, and allyltrimethoxysilane. One suitable organoalkoxysilane is RSN-5314 resin, available from Dow Corning of Midland, MI.

Other suitable silicone materials are silsesquioxanes having the following formula:

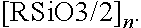

As discussed above, the organosiloxane polymer may be grafted onto a hydrophobic polymer, such as a polyester, to create a silicone-modified polymer of Formula (XI):

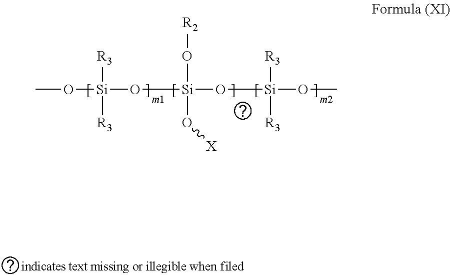

wherein R₂ is an OH functional polymer, R₃ is a H group, OH, alkyl, aryl, or alkoxy group, m1 is a first organosiloxane monomer, m2 is a second organosiloxane monomer, n is an organosiloxane monomer bound to a polymer and additional organosiloxane monomers, and X is a binding site for further polymer/silicone-modified polymer grafting.

A silicone resin may be formed by combining two or more of the silicone-modified polymers of Formula (XI) at binding site X. The silicone resin may be blended with the acid acrylic emulsifier to form the silicone acrylic polymer.

The film forming resin (the silicone-modified polymer/silicone resin) of Formula (XI) may be blended with the acid rich acrylic emulsifier to form a silicone acrylic polymer.

The resulting silicone acrylic polymer may be emulsified in water to create a silicone acrylic emulsion 24 of Formula (XII):

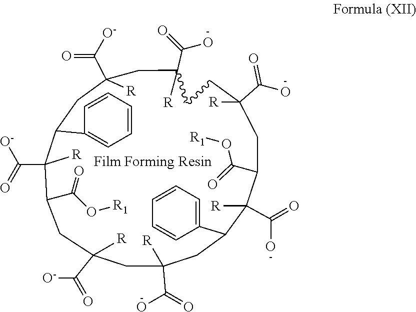

wherein R is a H or alkyl group, and R₁ is an alkyl, aryl, or silyl group.

The silicone acrylic emulsion 24 may be formulated into a silicone acrylic emulsion coating composition 100b by adding additives such as filler, pigments, crosslinkers, and rheology modifiers. Coating 100b may be a flexible, heat resistance coating.

The coating composition may comprise an amount of silicone acrylic emulsion 24 in an amount from 10 wt. %, 20 wt. %, or 30 wt. %, to 50 wt. %, 60 wt. %, or 70 wt. %, or within any range using any two of the foregoing as endpoints, such as 10 wt. % to 70 wt. %, 20 wt. % to 60 wt. %, or 30 wt. % to 50 wt. %, where wt. % is based on the total weight of the coating composition (“wet” weight).

The coating composition provided by the present disclosure may comprise a weight percentage of silicone acrylic emulsion 24 or, in a cured coating, the residue of such emulsion, in an amount from 10 wt. %, 20 wt. %, or 30 wt. %, to 50 wt. %, 60 wt. %, or 70 wt. %, or within any range using any two of the foregoing as endpoints, such as 10 wt. % to 70 wt. %, 20 wt. % to 60 wt. %, or 30 wt. % to 50 wt. %, where wt. % is based on the total weight of the solids components of the coating composition (“dry” weight).

### 1. Formation of a Polyester Polymer

A polyester polymer may include an alcohol component including a diol and a polyol, an acid component including terephthalic acid and isophthalic acid, wherein the terephthalic acid and isophthalic acid are present in a desired molar ratio. The polyester polymer may include carboxylic acid functional groups, having a weight average molecular weight (MW) of at least 5000 Daltons (Da), and an acid value (AV) of 40 to 65.

The polyester polymer may be film-forming and have reactive substituent groups, such as end groups, which may react with other molecules to modify the polymer in the manner described below. The polyester polymer having reactive groups is referred to as “functionalized” polyester, for example. The functional groups may be carboxyl (COOH) groups or hydroxyl (OH) groups which groups may be end groups of the polymer chains, such that polymer may be hydroxyl terminated. In this manner, the polyester polymer may be “functionalized” with hydroxyl groups and carboxyl groups, which aid in making the polymer water-soluble through neutralization with a corresponding base, such as dimethylethanolamine (DMAE), such that the polyester polymer may be formulated in aqueous-based coating systems.

The polyester polymer may comprise an alcohol component including a diol and a polyol, an acid component including two chemically distinct diacids, and free carboxylic acid functional groups. It has surprisingly been found the ratio of the diacids, such as isophthalic acid to terephthalic acid, may improve the balance of flexibility, elongation, and toughness of the polymer coating. The appropriate ratio also results in a high glass transition temperature.

The polyester polymer may have the structure shown in Formula (XIII) below:

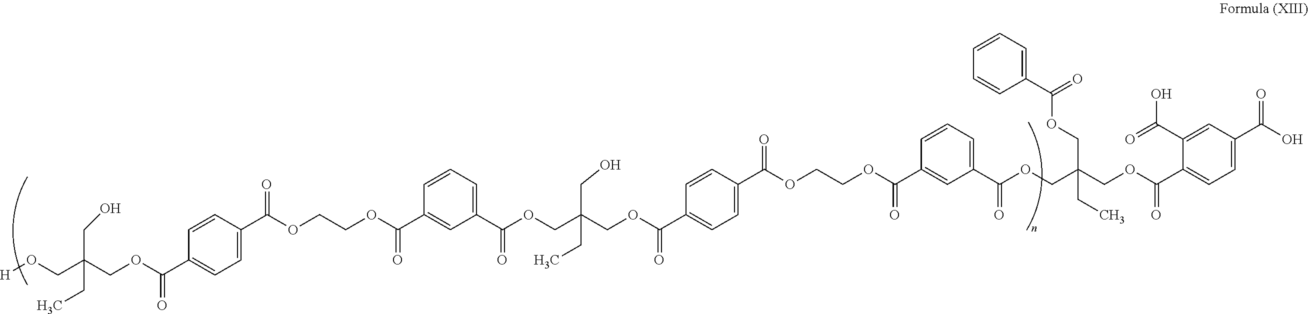

wherein n=2.

The polyester polymer may be prepared in two successive reaction stages. In a first stage, in the presence of a catalyst, an alcohol component including a diol component and a polyol component and an acid component including two chemically distinct diacids, may be reacted in the presence of an end-capping agent. In a second stage, the polyester polymer of the first stage may be reacted with an anhydride to install free carboxylic acids. Following the second stage, the mixture may be thinned with a solvent. The mixture may then be neutralized via addition of a base.

In the first stage, a polymer may be formed by reacting one or more diols, such as ethylene glycol, one or more polyols, such as trimethylolpropane, two chemically distinct diacids, such as isophthalic acid and terephthalic acid, and an end capping agent, such as benzoic acid, in the presence of a catalyst, such as titanium (IV) butoxide.

During the first stage, the reaction temperature may be at any value ranging from 80° C. or greater, 100° C. or greater, 120° C. or greater, 140° C. or greater, 160° or greater, or 180° C. or lower, 200° C. or lower, 220° C. or lower, or 240° C. or lower, any other range using these endpoints, such as from 80° C. to 240° C., from 120° C. to 200° C., or from 160° C. to 180° C. Also, water may be removed from the mixture until a desired AV (acid value) is reached. For example, water may be removed until the AV is less than 20, less than 15, less than 10, or greater than 5, or any other range using these endpoints such as from 5 to 20, from 5 to 15, or from 5 to 10. As used herein, “acid value (AV)” is defined as the number of milligrams of potassium hydroxide (KOH) required to neutralize one gram of a chemical substance.

During the first stage of the reaction, a catalyst may be used to facilitate the formation of the ester bonds. The catalyst may be a tin- or titanium-based catalyst. Suitable catalysts may include titanium (IV)-based catalysts and tin (IV)-based catalysts, such as titanium (IV) butoxide and dibutyltin dilaurate, for example.

During the first stage, the catalyst may be present in an amount of 0.01 wt. % or greater, 0.05 wt. % or greater, or 0.1 wt. % or lower, 0.2% or lower, or any other range using these endpoints, such as from 0.01 wt. % to 0.2 wt. %, or 0.05 wt. % to 0.1 wt. %, based on the total weight of the polyester.

In a second stage, an anhydride, such as trimellitic anhydride, may be added to the polymer to react with free hydroxyl groups, such as terminal hydroxyl groups, to endcap the polymer. Following the second stage, the mixture may be thinned with a solvent, such as ethylene glycol monobutyl ether. The mixture may further be treated under neutralization conditions using an amine base, such as dimethylethanolamine (DMEA).

During the second stage, the reaction temperature may be at any value ranging from 130° C. or greater, 140° C. or greater, 150° C. or greater, 160° C. or greater, 170° C. or lower, 180° C. or lower, 190° C. or lower, 200° C. or lower, 210° C. or lower, or any other range using these endpoints, such as from 130° C. to 210° C., from 140° C. to 190° C., or from 150° C. to 180° C.

After the second stage, the AV may be at any value ranging from 40 to or 65, such as 40 or greater, 45 or greater, 50 or greater, or 55 or lower, 60 or lower, 65 or lower, or any other range using these endpoints, such as 40 to 65, 50 to 60, or 45 to 55, for example.

Following the second stage, the mixture may be thinned to a desired solid content.

Suitable solvents that may be used include, but are not limited to, ethylene glycol monobutyl ether, diethylene glycol monomethyl acetate, propylene glycol monomethyl ether acetate, and mixtures of esters, such as Estasol, available from Chemoxy International, Middlesbrough, UK. [0041] The mixture may be neutralized by adding base. An amine base may be used for the neutralization. Suitable amine bases include, but are not limited to, dimethylethanolamine (DMEA), 2-amino-2-methyl-1-propanol, and aqueous ammonia.

In the polyester polymer, the weight percentage of the diol, such as ethylene glycol, or the combined weight percentage where more than one diol is used, as a percentage of the total polyester polymer weight, may comprise 8.0% or greater, 9.0% or greater, 10.0% or greater, 11.0% or greater, 12.0% or greater, 12.5%, or greater, or 13.0% percent or lower, 13.5% or lower, 14.0% or lower, 15.0% or lower, or 16% or lower. The diol, or more than one diol, may be present in the composition in a weight percentage of the total polymer ranging from 8.0% to 16.0%, such as 12.0% to 13.5%, 12.5% to 13.0%, or any other range combination using these endpoints.

In the polyester polymer, the weight percentage of the polyol, such as trimethylolpropane, or the combined weight percentage where more than one polyol is used, as a percentage of the total polyester polymer weight may comprise 20% or greater, 22% or greater, 24% or greater, 25% or greater, 26% or greater, 27% or greater, 28% or greater, 29% or greater, or 30% or lower, 31% or lower, 32% or lower, 33% or lower, 34%, or lower, 35% or lower, 37% or lower, or 40% or lower. The polyol, or more than one polyol, may be present in the composition in a weight percentage of the total polymer ranging from 20% to 40%, such as 29% to 33%, 28% to 32%, or any other range combination using these endpoints.

In the polyester polymer, the molar ratio of diol to polyol, such as ethylene glycol to trimethylolpropane, may be 0.3:1.0 or greater, 0.4:1.0 or greater, 0.5:1.0 or greater, 0.6:1.0 or greater, or 0.7:1.0 or lower, 0.8:1.0 or lower, 0.9:1.0 or lower, or any other range combination using these endpoints.

In the polyester polymer, the weight percentage of the first diacid, such as terephthalic acid, as a percentage of the total polyester polymer weight, may comprise 19.0% or greater, 19.5% or greater, 20.0% or greater, 20.5% or greater, 21.0% or greater, 21.5% or greater, 22.0% or greater, 22.5% or greater, or 23.0% or lower, 23.5% or lower, 24.0% or lower, 24.5% or lower, 25.0% or lower, 25.5% or lower, or 26.0% or lower. The first diacid may be present in the composition in a weight percentage of the total polymer ranging from 19.0% to 26.0%, 21.0% to 24.0%, or any other range combination using these endpoints.

In the polyester polymer, the weight percentage of the second diacid, such as isophthalic acid, as a percentage of the total polyester polymer weight may comprise 23.0% or greater, 23.5% or greater, 24.0% or greater, 24.5% or greater, 25.0% or greater, 25.5% or greater, 26.0% or greater, 26.5% or greater, or 27.0% or lower, 27.5% or lower, 28.0% or lower, 28.5% or lower, 29.0% or lower, 29.5% or lower, or 30.0% or lower. The second diacid may be present in the composition in a weight percentage of the total polymer ranging from 23.0% to 30.0%, 25.5% to 28.0%, 26.0% to 27.0%, or any other range combination using these endpoints.

In the polyester polymer, the molar ratio of the first diacid to the second diacid, such as terephthalic acid to isophthalic acid, may be 0.6:1.0 or greater, 0.7:1.0 or greater, or 0.8:1.0 or lower, 0.9:1.00 or lower, any range combination using these endpoints. For example, the ratio of terephthalic acid to isophthalic acid may be 0.86:1.00. The foregoing ratio of terephthalic acid to isophthalic acid facilitates balancing desired properties including flexibility, elongation and toughness of the polyester polymer while providing a high glass transition temperature.

In the polyester polymer, the weight percentage of the end-capping agent, such as benzoic acid, as a percentage of the total polyester polymer weight may comprise 1.0% or greater, 1.5% or greater, 2.0% or greater, or 2.5% or lower, 3.0% or lower, 3.5% or lower, or 4.0% or lower. The end-capping agent may be present in the composition in a weight percentage of the total polymer ranging from 1.0% to 4.0%, 2.0% to 2.5%, or any other range combination using these endpoints.

In the polyester polymer, the weight percentage of the anhydride, such as trimellitic anhydride, as a percentage of the total polyester polymer weight may comprise 5.0% or greater, 5.5% or greater, 6.0% or greater, or 6.5% or lower, 7.0% or lower, or 7.5% or lower. The anhydride may be present in the composition in a weight percentage of the total polymer ranging from 5.0% to 7.5%, 5.5% to 7.0%, or any other range combination using these endpoints.

The average molecular weight (MW) of the polyester polymer may be 5000

Daltons (Da) or greater, 7000 Da or greater, 8000 Da or greater, 10,000 Daltons (Da) or greater, 12,000 Da or greater, or 14,000 Da or lower, 16,000 Da or lower, 18,000 Da or lower, 20,000 Da or lower, or any range combination using these endpoints, such as from 5000 Da to 20,000 Da, from 10,000 Da to 18,000 Da, or from 12,000 Da to 16,000 Da, for example.

The glass transition temperature (Tg) of the polyester polymer may be 60° C. or greater, 70° C. or greater, 80° C. or greater, 85° C. or lower, 90° C. or lower, 95° C. or lower, or any range combination using these endpoints, such as from 60° C. to 95° C., or from 70° C. to 90°, for example.

Once the polymer is fully crosslinked, the Tg of the polyester polymer may be

80° C. or greater, 85° C. or greater, 90° C. or greater or greater, 95° C. or greater, 100° C. or greater, 110° C. or greater, or 115° C. or lower, 120° C. or lower, 125° C. or lower, 130° C. or lower, 135° C. or lower, or any range combination using these endpoints, such as 60° C. to 135° C., 80° C. to 125° C., or 95° C. to 120° C. For example, the Tg of the fully crosslinked polyester polymer may be 120° C.

c. Pathway 30

As seen in pathway 30 of FIG. 1, a silicone acrylic emulsion coating composition may be formed. The silicone acrylic emulsion coating composition may comprise an aqueous medium, a neutralizing agent, and emulsion particles. To form the emulsion particles, the acid acrylic shell polymer 11 may be blended with a silicone-modified polymer or silicone resin (the film forming resin) to create an acrylic silicone-modified polymer blend 32. The silicone-modified polymer/silicone resin may be of Formula (XI) formed from the process described in pathway 20.

The resulting acrylic silicone-modified polymer blend 32 may be emulsified in water to produce a silicone acrylic emulsion 34 of Formula (XII), similar to the silicone acrylic emulsion 24 of pathway 20 in FIG. 1.

The silicone acrylic emulsion 34 may be formulated into the silicone acrylic emulsion coating composition 100b, as described above in relation to pathway 20, by adding additives such as filler, pigments, crosslinkers, and rheology modifiers. Coating 100b may be a flexible, heat resistance coating.

ii. Solvent Borne Coating Compositions
d. Pathways 40a and 40b

As seen in pathways 40a and 40b of FIG. 1, an acrylic/silicone polymer blend coating composition 100c may be formulated from an acrylic/silicone polymer blend 42.

The acrylic/silicone polymer blend 42 may be formed by blending the acid acrylic shell polymer 11 with a silicone-modified polymer or silicone resin. The silicone-modified polymer/silicone resin may be the film forming resin of Formula (XI) formed from the process described in pathway 20.

Alternatively, the acrylic/silicone polymer blend 42 may be formed by neutralizing the acid acrylic polymer 11 to create an aqueous acid rich acrylic emulsifier 12 which may then be blended with a silicone-modified polymer or silicone resin.

The acrylic/silicone-modified polymer blend 42 may be directly formulated into an acrylic/silicone-modified polymer coating composition 100c by adding additives, as described below, such as filler, pigments, crosslinkers, and rheology modifiers. Coating 100c may be a flexible, heat resistance coating.

The acrylic/silicone-modified polymer coating composition 100c may comprise an amount of film forming resin in an amount from 50 wt. %, 60 wt. %, or 70 wt. % to 80 wt. %, 85 wt. %, or 90 wt. %, or within any range using any two of the foregoing as endpoints, such as 50 wt. % to 90 wt. %, 60 wt. % to 85 wt. %, or 70 wt. % to 80 wt. %, where wt. % is based on the total weight of the coating composition (“wet” weight).

The acrylic/silicone-modified polymer coating composition 100c may comprise an amount of film forming resin or, in a cured coating, the residue of such film forming resin, in an amount in an amount from 50 wt. %, 60 wt. %, or 70 wt. % to 80 wt. %, 85 wt. %, or 90 wt. %, or within any range using any two of the foregoing as endpoints, such as 50 wt. % to 90 wt. %, 60 wt. % to 85 wt. %, or 70 wt. % to 80 wt. %, where wt. % is based on the total weight of the solids components of the coating composition (“dry” weight).

### B. Additives

The water borne 100a, 100b and solvent borne 100c coating compositions may include additives, such as fillers, pigments, wetting agents, rheology modifiers, dispersing agents, crosslinkers, and flexibilizers.

i. Fillers

One or more fillers, in the form of inorganic particulate materials, may optionally be added to promote heat conductivity through the coatings 100a, 100b, 100c and/or for reinforcement for improving hardness. Additionally, fillers may add an abrasion resistance to the coating when applied to a substrate.

A suitable heat resistant filler is aluminum oxide (alumina, Al₂O₃), and other suitable heat resistant fillers include titanium dioxide (TiO₂), barium sulfate (BaSO₄), polyether ether ketone (PEEK), polyethersulfone (PES), and silicon carbide (SiC), Magnesium Fluoride (MgF₂), blanc fixe (BF or barium sulphate) and Calcium Fluoride (CaF₂).

The coating compositions provided by the present disclosure may comprise a weight percentage of filler from 0 wt. %, 1.0 wt. %, 1.5 wt. %, or 2 wt. % to 2.5 wt. %, 3.0 wt. %, 3.8 wt. %, or 4.0 wt. %, or within any range using any two of the foregoing as endpoints, such as 1 wt. % to 4.0 wt. %, 1.0 wt. % to 3.8 wt. %, 1.5 wt. % to 3.0 wt. %, or 2.0 wt. % to 2.5 wt. %, where wt. % is based on the total weight of the coating composition (“wet” weight).

The coating compositions provided by the present disclosure may comprise a weight percentage of filler from 0 wt. %, 1 wt. %, 10 wt. %, 15 wt. %, or 20 wt. %, to 25 wt. %, 30 wt. %, 35 wt. %, or 40 wt. %, or within any range using any two of the foregoing as endpoints, such as 1 wt. % to 40 wt. %, 10 wt. % to 35 wt. %, 15 wt. % to 30 wt. %, or 20 wt. % to 25 wt. %, where wt. % is based on the total weight of the solids components of the coating composition (“dry” weight).

ii. Pigments

To provide an aesthetic appearance to the coating, one or more pigments may be used. Suitable pigments include metal oxides, ochres, minerals, synthetic pigments, or pigments of biologic origin. The pigments may be used as powders or liquids may be formulated as a paste.

Based on the “dry” or solids weight of the coating composition after application to a substrate followed by curing, the coating composition provided by the present disclosure can comprise a weight percentage of pigment from 3 wt. %, 5 wt. %, 7 wt. %, 9 wt. %, or 11 wt. %, to 13 wt. %, 15 wt. %, 17 wt. %, or 20 wt. %, or within any range using any two of the foregoing as endpoints, such as 3 wt. % to 20 wt. %, 5 wt. % to 17 wt. %, 7 wt. % to 15 wt. %, or 9 wt. % to 11 wt. %, where wt. % is based on the total weight of the “dry” coating composition.

iii. Crosslinkers

The present coating compositions 100a, 100b, 100c may also include at least one optional crosslinker to form crosslink bonds between the base resin polymer chains to promote flexibility in the present coatings. Typically, the crosslinker will react via the functionalized reactive groups on the polymer chains, e.g., carboxyl or hydroxyl groups.

The crosslinker used for carboxyl group functionalized based resins may be a metal salt such as zinc ammonium carbonate or zinc oxide.

The crosslinker may be an amino-based or melamine crosslinker, for example, a melamine type crosslinker of Formula (XIV):

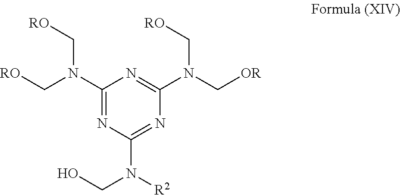

In one melamine type cross linker of the formula above, R may be H or C1-C6 alkyl.

The crosslinker may be a highly methylated, monomeric melamine crosslinker of Formula (XV):

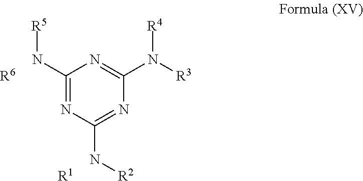

wherein R₁ to R₆ are each selected from —H, —CH₂OH, —CH₂OR₇, and may be the same or different, wherein R₇ is a C1 to C5 alkyl group. R₇ may be selected from —CH₃ or —C₄H₉. R1 to 5 may also each be —CH₂OCH₃. One suitable crosslinker is hexamethoxymethylmelamine, such as Cymel 303, available from Allnex SA of Brussels, Belgium.

Other crosslinkers may be of the glycoluril type of Formula (XVI):

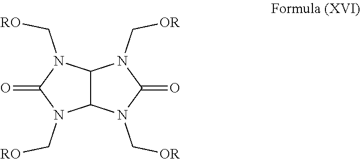

In the glycoluril type crosslinker of the formula above, R may be C1-C6 alkyl.

Further crosslinkers may be of the urea type of Formula (XVII):

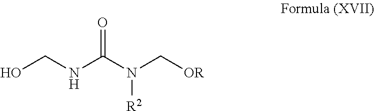

In the urea type crosslinker of the formula above, R may be a methyl or butyl and R2 may be H, C1-C6 alkyl, or alkoxy.

Still further crosslinkers may be of the benzo-guanamine type of Formula (XVIII):

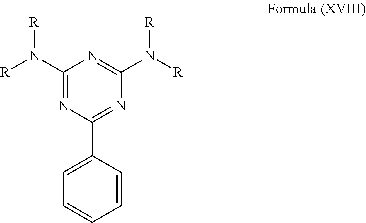

In the benxo-guanamine crosslinker of the formula above, R may be H, methoxyethyl, or ethoyethyl.

Still further crosslinkers include isocyanates, carbodiimides and dicyandiamides, as well as others.

The amount of crosslinker, based on the “wet” weight of the coating composition prior application to a substrate, i.e., the composition including water and, if present, organic solvents, followed by curing, may comprise 0 wt. % or greater, 0.2 wt. % or greater, 0.8 wt. % or greater, or 1 wt. % or lower, 2 wt. % or lower, or 10 wt. % or lower, or any other range combination using any two of the forgoing endpoints, such as 0 wt. % to 10 wt. %, 0.2 wt. % to 2 wt. %, or 0.8 wt. % to 1 wt. %.

Based on the “dry” or solids weight of the coating composition after application to a substrate followed by curing, the amount of crosslinker may comprise 0 wt. % or greater, 0.2 wt. % or greater, 0.8 wt. % or greater, or 2 wt. % or lower, 5 wt. % or lower, or 10 wt. % or lower, 20 wt. % or lower, or any other range combination using these endpoints, such as 0 wt. % to 20 wt. %, 0.2 wt. % to 10 wt. %, or 0.8 wt. % to 5 wt. %.

### IV. Substrates, Application and Curing of Coating Composition

The water borne and solvent borne coating compositions may be applied to a substrate by spray, roller coat, coil coating, screen printing, curtain coat or dipping and is then heat cured at various time/temperature conditions depending on the application.

### A. Substrates

The coating composition may be applied to the surface of a substrate. The substrate may have no prior treatment or be pre-treated. Pre-treatments of the substrate may include coating/s of primer, etching, anodizing, and other suitable forms of priming. Suitable substrates may include metals, ceramic materials, plastics, composites, and minerals. Suitable metals may include stainless steel, aluminum, and carbon steel. Suitable ceramic materials may include glasses like borosilicate glass, porcelain enamels, various fired clays and other refractory materials. Suitable plastics and composites may include high melting point plastics and composites, such as plastics having a melting point higher than the cure temperature of the coating formulation, including polyester, polypropylene, ABS, polyethylene, carbon fiber epoxy composites, and glass fiber epoxy composites. Suitable minerals may include micas, basalts, aluminas, silicas, and wollastonites, marble and granite.

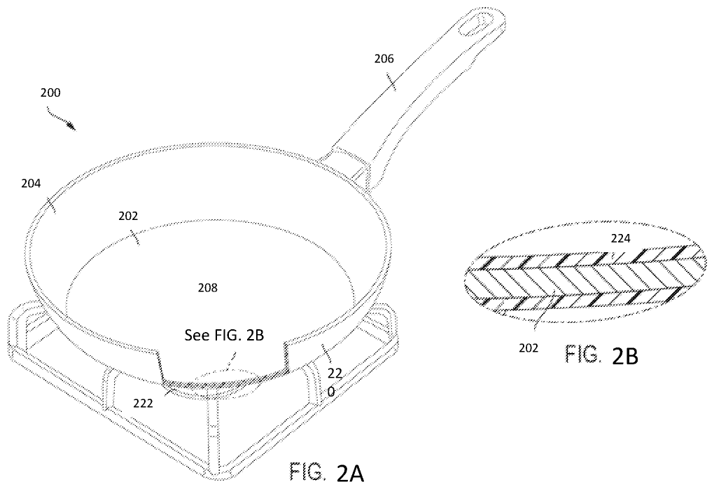

The substrate may be a portion of a pan or other article of cookware. Referring to FIG. 2A, an article of cookware 200 is shown in the form of a pan, which generally includes a circular bottom wall 202, an annular side wall 204, and a handle 206. Cookware article 200 is typically a metal or metal alloy such as stainless steel, aluminum, and carbon steel, but may also be a ceramic material, a plastic or a composite.

Bottom and side walls 202 and 204 include an interior or food contact surface 208 facing the food to be cooked, as well as an opposite, exterior or heat contact surface 220 which, in use, faces, is adjacent to, or contacts a heat source or heating element 222. As shown in FIG. 2B, article of cookware 200 may include an interior coating 224 over at least a portion of its respective interior surface, including at least a portion of, or all of, bottom wall 202 and/or side walls.

In this manner, the present coating compositions may be used as either an interior coating or an exterior coating. Although article of cookware 200 is shown as a pan, the present coating compositions may also be used to form coatings for cooking surfaces of other articles of cookware, such as skillets, griddles, pots and the like, as well as articles of bakeware or other cooking articles which are exposed to heat in use. Additionally, the present coating compositions may be used to form coatings on non-cooking surfaces of other cooking appliances such as grills.

The present coating compositions may also be used to coat non-cookware articles, such as rollers, molds, conduits and fasteners, which require a non-stick or release property and/or which are exposed to temperatures above ambient temperature in use.

### B. Application

The coating compositions 100a, 100b, 100c may each be applied using the following methods.

i. Spray Coating

The water borne and solvent borne coating compositions disclosed herein can be applied to a substrate using spray coating. Spray coating involves loading the coating composition into device wherein the coating composition is then forced through a nozzle such that the composition is made into a fine aerosol spray. The spray is then directed over a substrate for an even coating.

After spray coating a substrate with the coating composition, the coating composition can be initially flash cured at as little as 50° C. or as high as 120° C. to remove water. The sprayed coating composition may also be cured at a temperature from 170° C., 190° C., or 210° C. to 230° C., 250° C., or 280° C. for a period of time from 3 min., 7 min., or 11 min. to 13 min. 14 min., or 15 min., such as curing for 3 minutes at 274° C., curing for 10 minutes at 200° C., or curing for 15 minutes at 170° C.

ii. Roller Coating

Roller coating is the process of printing a composition onto a substrate using roll-to-roll technique. The roll-to-roll technique typically uses a single or multiple rollers, which wind the substrate over and through the roller/s covered in the printed composition. The composition is applied to the substrate as the substrate moves along the roller/s.

The coating compositions disclosed herein may be applied using the roller coating technique. The coating composition may be flash cured at as little as 50° C. or as high as 120° C. to remove water. The coating composition may also be cured for 10 minutes at 200° C., for 15 minutes at 170° C., or for 3 minutes at 274° C.

iii. Coil Coating

Coil coating is the process of applying a coating composition onto a substrate using a reverse roll technique. The coil may be passed through the coating head using a reel-to-reel technique using multiple rollers. The rollers rotate in the opposite direction of the coil and smear the coating composition onto the substrate. The coating composition may be applied to the substrate as the substrate moves along the rollers.

The coating compositions disclosed herein may be applied using the coil coating technique. The acrylic polymer, silicone/organically modified silicone composition can further be cured at 100° C. to remove solvent. The coil coated acrylic polymer, silicone/organically modified silicone composition may also be cured for 10-15 seconds at 360° C. to 400° C. Peak Metal Temperature.

iv. Screen Printed Coating

Screen print coating is the process of printing a composition onto a substrate using a mesh technique. The screen printing technique may use a single or multiple applications, to apply the coating to the substrate over and through a mesh covered in the coating composition. The coating composition is applied to the substrate as the substrate moves under the mesh.

The coating compositions disclosed herein may be applied using the screen printing technique. The coating composition 100b can further cured at as little as 50° C. or as high as 120° C. to remove water. The coating composition 100b may also be cured for 10 minutes at 200° C., for 15 minutes at 170° C., or for 3 minutes at 274° C.

v. Pre-Formed and Post-Formed Articles

The coating compositions 100a, 100b, 100c may be applied to pre- and post-formed articles while maintaining desirable properties.

Pre-formed articles may be articles formed from a substrate and cast into a desired final shape before application of a coating composition.

Post-formed articles may be articles formed from a substrate that is not yet in the desired final shape. The post-formed article is coated with the coating composition and then deformed or otherwise forced into the desired shape. Examples of the process of forming a substrate into a desired shape may include the deep draw process. Deep drawing is a process of deforming a substrate through mechanical action such that the substrate is formed into a specific structure. The process is performed with a punch and die. A punch is the desired shape of the substrate. The die is a cavity shaped to match the shape of the punch, while being slightly wider. The substrate is placed across the opening of the die and force is applied to each end of the substrate on either side of the opening to the cavity of the die. The punch is then used to apply force onto the substrate as it moves into the die cavity such that the substrate is forced into the die cavity into the shape of the punch. With a lot of force applied to the substrate, the deep drawing process may cause failures in the substrate material or cracking of any coating on the substrate. The coating compositions of the present disclosure may be applied and cured to an unformed substrate and withstand the forces of deep drawing, or other suitable forming process, to form the final article.

### V. Properties of Coating

The cured coating compositions 100a, 100b, and 100c may be both flexible and heat resistant, and demonstrate other properties as discussed below.

### A. Dry Film Thickness

Dry film thickness (DFT) is the thickness of a coating as measured above the substrate. The coating composition can be a single layer or multiple layers.

The cured coating compositions 100a, 100b, 100c may have a DFT from 10 microns, 15 microns, or 20 microns, 25 microns, 40 microns, or within any range using any two of the foregoing as endpoints, such as 10 microns to 40 microns, 15 microns to 25 microns, or 20 microns to 25 microns, where the DFT is measured according to TM-114A Electronic Gauge.

### B. Gloss

The gloss of a coating can be measured by comparing the specular reflectance of the coating to that of a black glass standard. This is done with an instrument that projects a beam of light at a fixed intensity and angle onto a surface and measuring the amount of reflected light at an equal but opposite angle.

The coating compositions 100a, 100b, 100c of the present disclosure may have a gloss from 100 GU, 150 GU, 155 GU, or 160 GU, to 165 GU, 170 GU, or 175 GU, or within any range using any two of the foregoing as endpoints, such as 150 GU to 175 GU, 155 GU to 170 GU, or 160 GU to 165 GU, where the gloss is measured at 60° C. according to ASTM D523 (2018).

### C. 0T Bend

The T bend test is performed to find flexibility of a composition during bending. The ability to bend is important for roller application of the composition. Compositions can be subjected to bending ranging from 0T to 5T. The 0T bend test involves subjecting the composition to a 1800 bend, according to ASTM D4145 (2018). A rating system, as seen in Table A, can be used to determine the score of a coating using the 0T Bend test.

TABLE A
0T Bend Test Score

| | Cracking of | Coating | Cracking | |
|---|---|---|---|---|
| | coating after | removal after | after | |
| Score | indent | tape pull | 0T Bend | Pass/Fail |
| 5 | 0% | 0% | 0% | Pass |
| 4 | >0-20% | >0-20% | >0-20% | Fail |
| 3 | 20-40% | 20-40% | 20-40% | Fail |
| 2 | >40-60% | >40-60% | >40-60% | Fail |
| 1 | >60% | >60% | >60% | Fail |

The composition is considered to “pass” if no film or piece of the composition comes off after being subjected to the 180° bending.

### D. Pencil Hardness

Pencil Hardness describes the capacity of a coating on a substrate to resist scratching, marring or gouging. The test utilizes a pencil of known hardness at a 45-degree angle to the coated surface at a constant force to determine the hardest pencil that will not scratch the coating.

The coating compositions of the present disclosure 100a, 100b, 100c may have a pencil hardness from 3H, 4H, or 5H, 6H, or within any range using any two of the foregoing as endpoints, where the pencil hardness is measured at ambient temperatures, e.g., at 20-23° C., according to ASTM D3363 (2022).

The coating compositions 100a, 100b, 100c of the present disclosure may have a pencil hardness from 2H, 3H, or 4H, 5H, or within any range using any two of the foregoing as endpoints, where the pencil hardness is measured at 204° C. according to ASTM D3363 (2022).

### E. Yellowing

As a coating composition cures, the coating can become yellowed due to the stability of the resin within the coating composition.

The stability of a resin may be tested dynamically or isothermally. The dynamic test measures the color change after 1 hour at each temperature (230° C., 260° C., and 274° C.).

The isothermal test measures the color change after 1 hour, 2 hours, and 4 hours at 274° C.

The color change of the coating composition may be measured using the standard reference method (SRM) chart from Beer Method 6 Color by The American Society of Brewing Chemists. The SRM of a sample may be measured in a cell path length of 1 cm with 430 nm wavelength light. The absorbance level measured is then multiplied by a factor of 12.7 to yield the color value assigned to the sample of wort, as seen in Formula I:

SRM=12.7×D×A₄₃₀

Typical SRM values are between 1 and 40, with 1 being described as “pale straw” and 40 being “dark black.”

### F. MEK Double Rubs

The resistance to solvents of a cured coating composition may be tested by using a methyl ethyl ketone (MEK) double rub (DR) test. The MEK DR test may be performed by placing a test panel on a flat table or other suitable flat, firm surface. Two sterile gauze pads may be affixed over the end of a one-pound Ball-Peen hammer. The gauze may be affixed such that it is snugly held in place with a rubber band and has four layers of gauze over the end of the hammer with no wrinkles.

The gauze is saturated with an appropriate solvent, such as methyl ethyl ketone (MEK), for the substrate being tested. The gauze is re-saturated every 25 double rubs.

A substrate coated with the coating composition is immediately rubbed with the saturated gauze over the test area using a back-and-forth stroke of 2-4 inches. The weight of the hammer controls the downward pressure.

The back-and-forth strokes may be continued, counting one “double rub” for each forward and backward motion completed until the bare substrate is exposed in the center of the strip where the rubs are performed or until 100 double rubs are achieved.

The number of “double rubs” are recorded as the test result. The gauze should be removed and replaced with new gauze in between each sample tested.

The curable composition of the present disclosure may have a solvent resistance of at least 40 MEK double rubs, at least 50 MEK double rubs, at least 70 MEK double rubs, or at least 90 MEK double rubs.

The MEK DR test may be coupled with a fingernail scratch test to determine softening of the coating. The fingernail scratch test comprises scratching the coating exposed to solvent and determining the softness and ability to recovery of the coating composition. A coating composition passes the fingernail scratch test if no coating can be scratched off after exposure to a solvent. A coating composition may pass the MEK double rubs test and then subsequently fail the fingernail scratch test if the coating composition shows no wear during the MEK double rubs test but then is soft enough to be scratched off during the fingernail scratch test.

### G. Forward Indent/Reverse Indent

The forward indent and reverse indent test may be performed and evaluated as to a “pass” and “fail” threshold according to ASTM D2794 (2019). In post forming applications where the three-dimensional shape of the coated article is formed after the coating has been applied and cured, the forward/reverse impact test is used to evaluate the ability of the coating to deform and stretch at speed. This test may also be coupled with a cross hatch adhesion test, as described below.

### H. Cross Hatch Adhesion

A cross hatch adhesion test may be performed and evaluated according to ASTM 3359 Method B, BS EN 12983-1:2023 8.3.1 (1977). The cross hatch adhesion method may be used to evaluate the adhesion of a coating composition to a substrate as well as the brittleness of the coating. Cross hatch is used to evaluate the robustness of the coating in use. The cross hatch test method may be combined with the water boil.

### I. Water Boil

The water boil test may include immersing a substrate coated with the coating composition in boiling water for an hour prior to other testing. The water boil test may determine if the coating is likely to prematurely fail if damaged.

### J. Shear Stability

A shear stability test may be performed to determine the ability of a coating composition to stay liquid within a solution after mixing. The test may be conducted by taking 200 g of a coating composition and mixing the coating using a high shear mixing blade mixer at 2000 RPM for 120 minutes. The coating composition receives a “pass” if the coating doesn't separate out of solution after mixing. If the coating composition does not stay liquid and separates out of the solution after mixing, the coating receives a “fail.”

### K. Freeze Thaw Stability

A freeze thaw stability test may be performed to determine the ability of a coating composition to be frozen and thawed repeatedly without separating out of solution. The test may be conducted by first measuring the viscosity of 200 g of a coating composition. The coating composition may then be placed in a sealed container and placing it in a freezer at −15oC until the coating composition is frozen. The coating composition is kept frozen for 3 hours. Once 3 hours has elapsed, the frozen coating composition may be taken out of the freezer and thawed naturally. During thawing, the coating composition is observed to check for any signs of separation of particles out of the solution. If the coating composition does not separate out of solution after completely thawed, the freezing and thawing process is repeated once again.

The cycle of freezing and thawing is done 5 times. After the last freeze thaw cycle, the viscosity of the coating composition may be measured and compared to the starting viscosity of the coating composition before the freeze thaw cycles. If there is no change in viscosity, the coating composition may receive a “pass” score. If there is a change in viscosity after 5 cycles, or the coating composition separates out of solution before completion of the 5 cycles, the coating composition receives a “fail.”

### L. EU Steak Cycles

A steak release test may be conducted to determine the ease of removal of a cooked steak from a substrate coated with a coating composition. The EU steak cycle test may be conducted in accordance with “Ovenware for use in traditional domestic ovens” according to EN 13834. The results may be evaluated using the rating scale provided in Table B below.

### M. BBQ/Mustard Release and Staining

The release and staining properties of a coating composition may be measured by cooking food, such as BBQ sauce, steak, eggs, mustard, in a bakeware/cookware article coated with a coating composition. Both release and staining tests may be performed according to EN 13834.

To test the release properties, a food item is cooked on a bakeware/cookware article coated with the coating composition and then evaluated for how easily the food item may be removed from the coated article. The first step for evaluating the ease of food removal may be be inversion of the cookware/bakeware. A coating that allows for food removal with just inversion may receive a rating of (5). The second food removal evaluation may involve gently shaking the bakeware/cookware (4 and 3 rating). And the final evaluation method for food removal may involve scraping with a spatula or other tool (2 and 1 rating). Table B describes the ratings for releasability. Articles coated with the coating compositions of the present disclosure may exhibit a “pass” release rating when mustard and BBQ sauce is cooked on the coated article.

TABLE B
Release Ratings for Coated Articles of Cookware/Bakeware

| | | Annex C | | |
|---|---|---|---|---|
| | | Cake Residue | Annex D | |
| | | Remaining Prior | Steak Residue | Pass/ |
| Score | Release | to Cleaning | During Cleaning | Fail |
| 5 | Complete | <20% | Residue easy to remove | Pass |
| 4 | Complete | 20-40% | Residue difficult to remove | Pass |
| 3 | Partial | 40-60% | Residue easy to remove | Pass |
| 2 | Partial | 60-100% | Residue difficult to remove | Pass |
| 1 | No | Cake Remaining | Stain or coating removal | Fail |

To test stain resistance properties, a food item is cooked on a bakeware/cookware article coated with the coating composition and then evaluated for how much staining the coated article has after cooking as described in Table C. Articles coated with the coating compositions of the present disclosure may exhibit a staining rating of at least 3, at least 4, or at least 5 when mustard and BBQ sauce is cooked on the coated article.

TABLE C
Staining Ratings for Coated Articles of Cookware/Bakeware

| | | Staining |
|---|---|---|
| Score | Release | After Cleaning |
| 5 | Complete | None |
| 4 | Complete | Shadow |
| 3 | Partial | Slight |
| 2 | Partial | Moderate |
| 1 | No | Heavy |

### N. Cupping

A cupping test may be completed on a preformed article coated in one of the coating compositions according and evaluated using BS 3900-E4. In post forming applications where the three-dimensional shape of the coated article is formed after the coating has been applied and cured, the cupping test is used to evaluate the coating's ability to elongate with the substrate.

A coated panel may be placed face up on a test jig and clamped into place. A ball bearing may be raised through the q-panel to stretch the coating. The deformation height may be set to 6 mm (depending on the gauge of panel and annealing of the substrate). The coating composition may be evaluated using ASTM 643 (2015).

### O. Viscosity Zahn #4

A Zahn Cup-Type Viscosimeter is a portable device for quickly measuring the viscosity of a fluid, such as paint, lacquer, varnish, syrup, creams, oils, and coating compositions. The viscosity of the liquid measured by this device may be expressed in Zahn numbers. Zahn numbers are the time in seconds required for the definite volume (44 mL0 of liquid to flow through the viscosimeter.

The coating compositions of the present application may have a Zahn number from 20 s, 25 s, 30 s, to 35 s, 40 s, 45 s, or any range using the foregoing values as endpoints, such s 20-45 s, 25-40 s, or 30-35 s.

### Q. Emulsion Stability

The formulation and stabilization of an emulsion may be desired in many of the present coating formulations. Assessments may be made during each stage of the manufacturing process to determine the effects of time and temperature on the stability of the emulsion and subsequent formulated emulsion coating composition. Dynamic light scattering may be used to assess particle size and the formation of the emulsion particle and distribution of the particles over time at a given temperature may be monitored by visual assessment.

The visual assessment may be done by observation of the following characteristics in Table D:

TABLE D
Emulsion Stability Visual Assessment Rating

| Rating | Appearance Observed |
|---|---|
| 5 | No Phase Separation |
| 4 | Slight evidence of phase separation or settling |
| 3 | Phase separation that can be mixed back in by shaking |
| 2 | Phase separation that can be mixed back in by mixing |
| 1 | Phase separation that cannot be mixed back in |

### R. VOC

In many locations, there are environmental standards to limit the level of VOCs that can be present in coating compositions. VOC are compounds that have a high vapor pressure, generally 10 Pa or more at 20° C., and low water solubility.

The hybrid core shell acrylic emulsion coating composition 100a of the present disclosure may comprise minimal VOCs, for example, below the thresholds of the United States Environmental Protection Agency (U.S. EPA) of 3.5 lbs/gal or less and/or the European standard of 420 g/liter. The hybrid core shell acrylic emulsion coating composition 100a may comprise an amount of VOCs from less than 200 g/liter, less than 150 g/liter, less than 100 g/liter, less than 50 g/liter, less than 10 g/liter, or less than 5 g/liter, or within any range including any two of the foregoing values as end points, such as 5 g/liter to 200 g/liter, 10 g/liter to 150 g/liter, or 50 g/liter to 100 g/liter.

The silicone acrylic emulsion coating composition 100b may comprise a level of VOCs that is compliant with VOC restrictions of some states. The silicone acrylic emulsion coating 100b may comprise an amount of VOCs from less than 370 g/liter, less than 300 g/liter, less than 250 g/liter, less than 200 g/liter, less than 150 g/liter, or less than 100 g/liter, or within any range including any two of the foregoing values as end points, such as 100 g/liter to 370 g/liter, 150 g/liter to 300 g/liter, or 200 g/liter to 250 g/liter.

### S. Fluoropolymers

The present coating compositions may lack fluoropolymers, wherein the coating composition is fluoropolymer-free. Per- and polyfluoroalkyl substances (PFAS) are fluorine-containing chemical compounds including perfluoroalkyl acids (PFAAs) such as perfluorooctanoic acid (PFOA), and/or perfluorooctane sulfonate (PFOS).

The amount PFAS in a coating composition may be determined by liquid chromatography-tandem mass spectrometry (LC-MS/MS), which may be practiced using isotope dilution. The dry limit of quantification (LOQ) may be less than 1 part per million (ppm), or 1 part per billion (ppb).

As used herein, “PFAS free” means a polymer, a liquid chemical coating composition, or an as-applied coating which includes a PFAS content of 1 ppm or lower.

As used herein, “fluorine free” means a polymer, a liquid chemical coating composition, or an as-applied coating which includes a fluorine content of 1.0 wt. % or lower, 0.5 wt. % or lower, or 0.1 wt. % or lower, wherein wt. % is based on the total weight of the coating composition.

### EXAMPLES

Aspects of the present disclosure are further illustrated by reference to the following examples. It will be apparent to those skilled in the art that many modifications, both to materials, and methods, may be practiced without departing from the scope of the disclosure.

### Example 1—Acrylic Polymer Shell Formation

This example describes the formulation of the first polymer, an acid acrylic shell polymer, made from the following components in Table 2.

TABLE 2
Acrylic Polymer Shell Formulation

| | Ex. 1A | | Ex. 1B | | Ex. 1C | | Ex. 1D | |
|---|---|---|---|---|---|---|---|---|
| | | Wt. % of | | Wt. % of | | Wt. % of | | Wt. % of |
| | | acid | | acid | | acid | | acid |
| | | monomers | | monomers | | monomers | | monomers |
| | | based on | | based on | | based on | | based on |
| | | total | | total | | total | | total |
| | Weight | monomeric | Weight | monomeric | Weight | monomeric | Weight | monomeric |
| Component | (g) | components | (g) | components | (g) | components | (g) | components |
| Methacrylic Acid | 235.4 | 42.5 | 235.4 | 42.5 | | 36.5 | | 36.5 |
| Acrylic Acid | | | | | 285.0 | | 285.0 | |
| Ethyl acrylate | 149.4 | | 149.4 | | 240.0 | | 240.0 | |
| Styrene | 168.8 | | 168.8 | | 255.0 | | 255.0 | |
| Dowanol PM | 135.0 | | 135.0 | | — | | — | |
| n-Amyl alcohol | — | | — | | 181.7 | | 181.7 | |
| Butyl Cellosolve | 378.5 | | 378.5 | | 413.8 | | 413.8 | |
| Dimethylethanolamine | 131.4 | | — | | 165.4 | | — | |
| Deionized water | 978.8 | | — | | 1450.6 | | — | |

### Example 2—Acrylic Emulsifier Core Formation

This example describes the synthesis of the aqueous acid acrylic emulsifier core.

TABLE 3
Acrylic Emulsifier Core Formulation

| | Example 2A | Example 2B |
|---|---|---|
| Component | Weight (g) | Weight (g) |
| Polymer of Example 1A | 360.0 | — |
| Polymer of Example 1C | — | 360.0 |
| Styrene | 134.4 | 134.4 |
| Ethyl acrylate | 75.4 | 75.4 |
| Glycidyl methacrylate | 23.2 | 23.2 |
| Methyl methacrylate | 126.8 | 126.8 |
| Deionized water | 1205.39 | 1205.39 |

### Example 3—Hybrid Core Shell Acrylic Emulsion Coating Formulation

This Example describes a clear hybrid core-shell acrylic emulsion coating formulation using the acid acrylic emulsifier core made in accordance with Examples 2A and 2B. Table 1 below gives the wt. % of each element in the formulation.

TABLE 4
Hybrid Core-Shell Acrylic Emulsion Coating Formulation

| | | Example | Example |
|---|---|---|---|
| | | 3A | 3B |
| Ingredients | Description | (wt. %) | (wt. %) |
| Example 2A | Acrylic Hybrid Latex | 91.68 | — |
| Example 2B | Acrylic Hybrid Latex | — | 86.13 |
| Dimethylethanolamine | pH Adjustment | 0.48 | 1.05 |
| n-Butanol | Solvent | 3.28 | 1.05 |
| Cymel 303LF | Crosslinker | 4.28 | 5.68 |
| Twin 4100 | Wetting aid | 0.28 | 0.35 |
| Tego Glide 407 | Slip and Flow Aid | — | 0.08 |
| Butyl Cellosolve | Solvent | — | 0.76 |
| Foamex 825 | Defoamer | — | 0.32 |
| De-ionized water | Solvent | — | 3.43 |
| Rheolate 310D | Rheology Modifier | — | 1.05 |
| Surfynol 440 | Wetting Aid | — | 0.1 |

| | | Example | Example |
|---|---|---|---|
| TEST | Description | 3A | 3B |
| Dry Film Thickness | Measure (μm) | 15-20 | 15-20 |
| Gloss | At 60° | 170 | 93 |
| MEK | Double rub | 50 | 50 |
| Pencil hardness | At Ambient (20-25° C.) | 5H | 3H |
| Pencil hardness | At 400° F. | 3H | H |
| 0T bend | No loss of adhesion | Pass | Pass |
| Indent reverse/direct | No cracking | Pass/Pass | Pass/Pass |
| Yellowing Resistance | 4 hr at 465° F. | Pass | Pass |
| Dishwasher test | 5 days 0.4M NaOH soak | Pass | Pass |
| Plastic odor test | 15 minutes direct flame | Pass | Pass |
| Direct Flame Test | 60 mins Water Boil | Pass | Pass |

The above hybrid core-shell acrylic emulsion coating composition may be applied using roller coat or spray techniques as described above. Once applied and cured, the coating composition had a DFT of 10 microns.

The applied coating had a gloss of 93-170 GU at 60° C. according to ASTM D523 (2018).

When subjected to a 0T bend test according to ASTM D4145 (2018), the coating of the present disclosure received a pass result.

The coating had a pencil hardness of 3H at ambient temperature according to ASTM D 3363 (2022), and a pencil hardness of at least H at a temperature of 400° F. (204° C.) according to ASTM D 3363 (2022).

The hybrid core-shell acrylic emulsion coating composition exhibited minimized yellowing on cure based on visual inspection.

### Example 4—Coating Formulations with Fillers

This Example describes formulations of acrylic coating compositions each comprising a core-shell type latex polymer made according to Examples 2B, together with fillers. The weight percent of each ingredient is based on the total weight of the coating composition (“wet” weight), and the formulations are set forth below in Table 2.

TABLE 5
Coating Formulations

| | | | Example 4B | Example 4C |
|---|---|---|---|---|
| | | Example 4A | Blanc Fixe | Calcium |
| | | Alumina | (barium sulphate) | fluoride |
| | | filler | filler | filler |
| Ingredient | Description | (Wt. %) | (Wt. %) | (Wt. %) |
| Hybrid Core-Shell | Hybrid Core-Shell | 82.74 | 82.74 | 82.74 |
| Acrylic of Examples 2B | Acrylic polymer | | | |
| Dimethylethanolamine | Amine for pH adjustment | 0.43 | 0.43 | 0.43 |
| n-butanol | Co-solvent for crosslinker | 2.96 | 2.96 | 2.96 |
| Cymel 303LF | Melamine crosslinker | 3.86 | 3.86 | 3.86 |
| Twin 4100 | Surfactant | 0.25 | 0.25 | 0.25 |
| De-ionized Water | DI water | 2.18 | 2.18 | 2.18 |
| Butyl Cellosolve | Solvent | 0.59 | 0.59 | 0.59 |
| Byk 192 | Dispersant | 0.16 | 0.16 | 0.16 |
| Foamblast 825 | Defoamer | 0.02 | 0.02 | 0.02 |
| Oleic Acid | Additive | — | — | 0.03 |
| Alumina | Aluminum oxide filler | 3.81 | — | — |
| Blanc Fixe | Barium sulphate filler | — | 3.81 | — |
| CaF₂ | Calcium fluoride filler | — | — | 3.81 |
| Red pigment | R316054B pigment | 3 | 3 | 3 |

The inclusion of fillers in Example 4B did not have a detrimental effect on the coating, as compared to the coating formulations Example 3A and 3B. However, the inclusion of filler in Example 4A did have an effect on the pencil hardness.

### Example 5—Coating Compositions and Applications

The resulting composition from the two-step polymerization of Examples 1 and 2, as well as the coating compositions of Examples 3 and 4, are hybrid core-shell acrylic emulsion coating compositions that are used on bakeware, cookware, grills, and other substrates. The coating compositions, after application and curing, form a non-stick, heat-resistant, abrasive resistant surface on the substrate.

### Example 6—Silicone Acrylic Emulsion Formation

This example describes the formation of the silicone acrylic emulsion, where the acid rich acrylic emulsifier is blended with a silicone resin/silicone-modified polymer (the film forming resin), a neutralizing agent and water and emulsified.

Table 6 shows exemplary silicone-modified polymers/silicone resins used as a film forming resin to create the coating compositions of the present disclosure. Silicone polyesters are all made in accordance with the discussion in section II.A.i.b.1. Formation of A Polyester Polymer.

TABLE 6
Silicone-modified polymers/Silicone Resins

| Silicone-modified | | Silicone | Organic | | | |
|---|---|---|---|---|---|---|
| polymer/Silicone | | Resin | Resin | Resin | Solvent | Primary |
| Resin | Abbr. | Ratio | Ratio | (wt. %) | (wt. %) | Solvent |
| Silicone | SP1 | 60 | 40 | 70 | 30 | Methyl n- |
| Polyester 1 | | | | | | Amyl Ketone |
| Silicone | SP2 | 50 | 50 | 60 | 40 | Methoxy |
| Polyester 2 | | | | | | Propyl |
| | | | | | | Acetate |
| Silicone | SP3 | 50 | 50 | 50 | 50 | Xylene |
| Polyester 3 | | | | | | |
| Silicone | SP4 | 40 | 60 | 60 | 40 | Methoxy |
| Polyester 4 | | | | | | Propyl |
| | | | | | | Acetate |
| Silicone | SP5 | 30 | 70 | 63 | 37 | Methoxy |
| Polyester 5 | | | | | | Propyl |
| | | | | | | Acetate |
| Silicone | SP6 | 15 | 85 | 68 | 32 | Methoxy |
| Polyester 6 | | | | | | Propyl |
| | | | | | | Acetate |
| Silicone | SP7 | 10 | 90 | 68 | 32 | Methoxy |
| Polyester 7 | | | | | | Propyl |
| | | | | | | Acetate |
| Silicone | SPE1 | 30 | 70 | 50 | 1.5 | DI Water |
| Polyester | | | | | | |
| Emulsion 1 | | | | | | |
| Silicone | SI1 | 100 | 0 | 66 | 34 | Methoxy |
| Intermediate 1 | | | | | | Propyl |
| | | | | | | Acetate |
| Silicone 1 | S1 | 100 | 0 | 66 | 34 | Methoxy |
| | | | | | | Propyl |
| | | | | | | Acetate |
| Silicone 2 | S2 | 100 | 0 | 66 | 34 | Dimethoxy |
| | | | | | | Propanol |
| Silicone 3 | S3 | 100 | 0 | 66 | 34 | Methoxy |
| | | | | | | Propyl |
| | | | | | | Acetate |
| Silicone 4 | S4 | 100 | 0 | 66 | 34 | Dimethoxy |
| | | | | | | Propanol |
| Waterborne | WBP1 | 0 | 100 | 60 | 40 | DI Water |
| Polyester 1 | | | | | | |

Table 7 describes the same emulsion blend manufactured in four different ways. Each step (1 or 2) represents a blend of components when added to the mixture. Each component is added according to the step indicated (1 or 2) and mixed under high shear mixing.

TABLE 7
Silicone Acrylic Emulsion Combinations

| | | Blend | Blend | Blend | Blend |
|---|---|---|---|---|---|
| Ingredient | Description | A | B | C | D |
| SP2 | Film forming Resin | 1 | 1 | 1 | 1 |
| Example 1D | Acid Rich | 1 | 1 | 1 | 2 |
| | Acrylic polymer | | | | |
| N,N-Dimethyl | Neutralizing agent | 1 | 1 | 2 | 2 |
| Ethanolamine | | | | | |
| De-ionized water | Continuous Phase | 1 | 2 | 2 | 2 |

Table 8 describes the desired loading levels for emulsion stability in the formation of the silicone acrylic emulsion coating composition, where the acid rich acrylic polymer from Example 1 is blended with the silicone-modified polymer/silicone resin (film forming resin), a neutralizing agent and water and emulsified via Blend C method.

TABLE 8
Loading Levels for Silicone Acrylic Emulsion

| | Ex. 6a | Ex. 6b | Ex. 6c | Ex. 6d | Ex. 6e |
|---|---|---|---|---|---|
| Ingredient | (wt. %) | (wt. %) | (wt. %) | (wt. %) | (wt. %) |
| SP 2 | 62.4% | 61.1% | 59.8% | 58.3% | 57.0% |
| Example 1D | 3.7% | 5.4% | 7.1% | 8.6% | 10.1% |
| De-ionized water | 33.7% | 33.3% | 32.9% | 32.7% | 32.5% |
| N,N-Dimethyl | 0.17% | 0.25% | 0.33% | 0.40% | 0.47% |
| Ethanolamine | | | | | |
| AS on SP | 5.0% | 7.5% | 10.0% | 12.5% | 15.0% |

Table 9 describes the emulsion stability of the silicone acrylic emulsion over periods of time and in different environments.

TABLE 9
Emulsion Stability of Silicone Acrylic Emulsion Formulations

| | Ex. | Ex. | Ex. | Ex. | Ex. |
|---|---|---|---|---|---|
| Emulsion Stability | 6a | 6b | 6c | 6d | 6e |
| Initial Water Washable Mixer Blade | 4 | 4 | 5 | 5 | 5 |
| 1 Week Water Washable Spatula | 2 | 3 | 3.5 | 4 | 4 |
| Initial Water Dilutable | 5 | 5 | 5 | 5 | 5 |
| Water dilutability (10 wt. %) | 5 | 5 | 5 | 5 | 5 |
| Water Dilutability re-dispersibility (10 wt. %) | 5 | 5 | 5 | 5 | 5 |
| 10% Overnight Settling | 1 | 1 | 3 | 4 | 5 |
| 1 Week Phase Separation | 5 | 5 | 5 | 5 | 5 |
| Phase Separation 6-month RT | 3 | 5 | 5 | 5 | 5 |
| Spatula Water Washability 6-month RT | 3 | 5 | 5 | 5 | 4 |

1 = Worst,
5 = Best

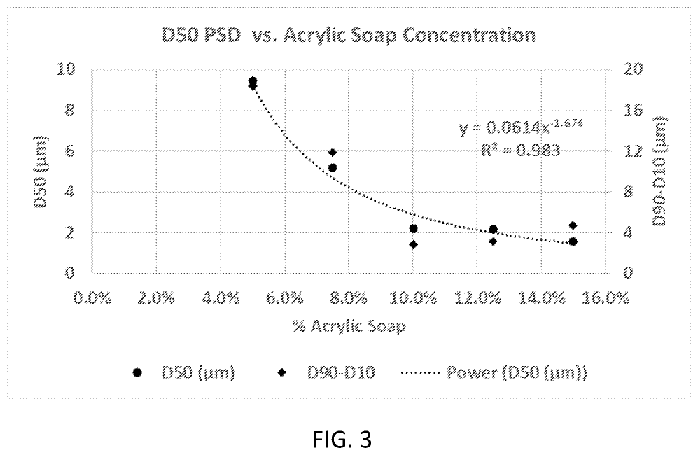

FIG. 3 illustrates desired particle size reduction as measured by Microtrac S2000 particle size analyzer to determine the wt. % acrylic emulsifier on film forming resin needed to achieve and stabilize the median for a volume distribution (D50) and the spread of the (D90−D10) in the formation of the silicone acrylic emulsion as determined by dynamic light scattering ISO 13320-1, where the acid rich acrylic resin is blended with a film forming resin, a neutralizing agent and water and emulsified via Blend C method. The blends of the present disclosure may have a D50 of 0.01 μm, 1 μm, or 3 μm to 5 μm, 7 μm, or 10 μm as determined by dynamic light scattering ISO 13320-1.

Table 10 describes the formation of the silicone acrylic emulsion, where the acid rich acrylic resin is blended with a silicone film forming resin selected from Table 6, a neutralizing agent and water and emulsified using pathway 30, Blend C from Table 7.

TABLE 10
Silicone Acrylic Emulsion

| | | Ex. | Ex. | Ex. | Ex. | Ex. | Ex. | Ex. | Ex. | Ex. | Ex. | Ex. |
|---|---|---|---|---|---|---|---|---|---|---|---|---|
| Ingredient | Unit | 6f | 6g | 6h | 6i | 6j | 6k | 6l | 6m | 6n | 6o | 6p |
| Silicone Film | | S1 | SI 1 | SP1 | SP2 | SP3 | SP4 | SP5 | SP6 | SP7 | S1 | S1 |
| Forming Resin | (wt. %) | 60.3 | 58.2 | 59.9 | 60.7 | 61.5 | 60.7 | 60.5 | 60.1 | 60.1 | 48.8 | 57.8 |
| 10% Polyamide | (wt. %) | — | — | — | — | — | — | — | — | — | 16.1 | — |
| imide | | | | | | | | | | | | |
| DC 200 | | — | — | — | — | — | — | — | — | — | — | 0.2 |
| 350 cSt | | | | | | | | | | | | |
| Dowsil | | — | — | — | — | — | — | — | — | — | — | 0.4 |
| 1-9770¹ | | | | | | | | | | | | |
| Example 1D | (wt. %) | 8.0 | 10.8 | 8.4 | 7.3 | 6.2 | 7.3 | 7.6 | 8.2 | 8.2 | 9.3 | 11.1 |
| N,N-Dimethyl | (wt. %) | 0.5 | 0.6 | 0.5 | 0.4 | 0.4 | 0.4 | 0.5 | 0.5 | 0.5 | 0.4 | 0.5 |
| Ethanolamine | | | | | | | | | | | | |
| De-ionized | (wt. %) | 31.3 | 30.3 | 31.2 | 31.6 | 32.0 | 31.6 | 31.5 | 31.3 | 31.3 | 25.4 | 30.0 |
| water | | | | | | | | | | | | |
| Solids | (wt. %) | 44 | 60 | 46 | 40 | 34 | 40 | 42 | 45 | 45 | 39 | 45 |
| VOC | (g/L) | 268 | 107 | 243 | 305 | 368 | 305 | 286 | 255 | 255 | 256 | 247 |

¹Dowsil 1-9770 is a release aid sourced from Dow.

Table 11 describes the wt. % of silicone contained within the film forming resin (silicone-modified polymer/silicone resin) and the influence the wt. % of silicone has on the ability of the acid rich acrylic resin to develop a stable emulsion over long periods of time, stable under dilution and can be cleaned up without the need of solvents. This deficiency maybe overcome by tailoring the monomers and/or monomer ratios used to create the first stage acid rich acrylic resin.

TABLE 11
Properties of Silicone Acrylic Emulsion Based on Silicone
wt. % in Silicone-Modified Polymer/Silicone Resin

| | Ex. | Ex. | Ex. | Ex. | Ex. | Ex. | Ex. | Ex. | Ex. | Ex. | Ex. |
|---|---|---|---|---|---|---|---|---|---|---|---|
| (FFR) | 6f | 6g | 6h | 6i | 6j | 6k | 6l | 6m | 6n | 6o | 6p |
| Silicone | 100 | 100 | 60 | 50 | 50 | 40 | 30 | 15 | 10 | 100 | 100 |
| Content of | | | | | | | | | | | |
| FFR (wt. %) | | | | | | | | | | | |
| Initial Water | 4 | 4 | 4 | 5 | 4 | 4 | 5 | 4 | 1 | 4 | 4 |
| Washable | | | | | | | | | | | |
| 1 Day Water | 5 | 5 | 4.5 | 5 | 4.5 | 4.5 | 5 | 5 | 1 | 5 | 5 |
| Washable | | | | | | | | | | | |
| Water Dilutability | 5 | 5 | 5 | 5 | 5 | 5 | 5 | 5 | 1 | 5 | 5 |
| (10 wt. %) | | | | | | | | | | | |
| WD (10 wt. %) | 5 | 5 | 5 | 5 | 5 | 5 | 5 | 5 | 1 | 5 | 5 |
| Re-dispersible | | | | | | | | | | | |
| Overnight RT | 5 | 5 | 5 | 5 | 5 | 5 | 5 | 5 | 1 | 5 | 5 |
| Settling | | | | | | | | | | | |
| 28 days D PSD | 5 | 5 | 3 | 5 | 5 | 5 | 3 | 3 | 1 | 5 | 5 |
| 28 days 50° C. | 5 | 5 | 5 | 5 | 5 | 5 | 1 | 1 | 1 | 5 | 5 |
| Phase Separation | | | | | | | | | | | |
| 28 days 50° C. | 5 | 5 | 5 | 5 | 3 | 5 | 1 | 1 | 1 | 5 | 5 |
| Settling | | | | | | | | | | | |
| 28 days 50° C. | 5 | 5 | 5 | 5 | 5 | 5 | 1 | 1 | 1 | 5 | 5 |
| Water Washable | | | | | | | | | | | |

1 = Worst
5 = Best
Water washability is assessed by dipping a spatula into the emulsion and using a wash bottle in a steady stream washing the emulsion from the blade of the spatula. This is done first from the bottom up then on the reverse side from the top down to simulate dilution. The observation was o see an “oily” layer or separation of the emulsion leaving a polymer residue then the emulsion is deemed unstable.

Table 12 describes the formation and properties of a silicone acrylic emulsion coating composition.

TABLE 12
Silicone Acrylic Emulsion Coating Composition

| | | Basecoat | Topcoat |
|---|---|---|---|
| | | Ex. 7a | Ex. 7b |
| | Description | (wt. %) | (wt. %) |
| Ingredients | | | |
| Example 60 | Film Forming Resin | 77.68 | — |
| Example 6p | Film Forming Resin | — | 74.30 |
| De-ionized water | Diluent | 10.93 | 14.86 |
| Propylene glycol 300 | Film former | 1.90 | 1.49 |
| Foamex 389 | Defoamer | 0.1 | 0.1 |
| Keystone black | Pigment | 4.56 | — |
| Silicon Carbide C 1200W | Filler | 2.28 | — |
| ASE 60 Pregel | Rheology modifier | 2.55 | 2.23 |
| Rheolate 310D | Rheology modifier | — | 6.31 |
| N,N-Dimethyl Ethanolamine | Neutralizing agent | — | 0.71 |
| TEST | | | |
| Viscosity Zahn #4 | | 33.6 s | 24.2 s |
| pH | | 7.50 | 7.11 |
| BBQ Release | | — | 4 |
| 1 hr at 350 F. | | | |
| BBQ Stain Test | | — | 5 |
| 1 hr at 350 F. | | | |
| Mustard Release | | — | 5 |
| 1 hr at 350 F. | | | |
| Mustard Stain Test | | — | 5 |
| 1 hr at 350 F. | | | |
| Forward Indent | | Pass | Pass |
| Reverse Indent | | Pass | Pass |
| Cupping Test | | Pass | Pass |

Table 13 describes the formulation and properties of a basecoat layer to provide adhesion to the substrate and a topcoat layer to provide release.

TABLE 13
Basecoat and Topcoat Formulation

| | | Basecoat | Topcoat |
|---|---|---|---|
| | | Ex. 7c | Ex. 7d |
| | Description | (wt. %) | (wt. %) |
| Ingredients | | | |
| Example 6f | Film Forming Resin | 62.14 | 69.44 |
| Example 6i | Film Forming Resin | 15.54 | 14.86 |
| De-ionized water | Diluent | 10.93 | 14.86 |
| Propylene glycol 300 | Film former | 1.90 | 1.49 |
| Foamex 389 | Defoamer | 0.1 | 0.1 |
| Keystone black | Pigment | 4.56 | — |
| Silicon Carbide C 1200W | Filler | 2.28 | — |
| ASE 60 Pregel | Rheology modifier | 2.55 | 2.23 |
| Rheolate 310D | Rheology modifier | — | 6.31 |
| N,N-Dimethyl Ethanolamine | Neutralizing agent | — | 0.71 |
| TEST | | | |
| Pencil Hardness at 20-25° C. | | 5H | 5H |
| Forward Indent | | Pass | Pass |
| Reverse Indent | | Pass | Pass |
| Cupping Test | | Pass | Pass |

Table 14 describes the formulation and properties of silicone acrylic emulsion coating compositions and their properties.

TABLE 14
Silicone Acrylic Emulsion Basecoat and Topcoat Compositions

| | | Basecoat | Topcoat | | |
|---|---|---|---|---|---|
| | | (BC) | (TC) | BC/TC | BC/TC |
| | Description | (wt. %) | (wt. %) | (wt. %) | (wt. %) |
| Ingredients | | | | | |
| Example 6i | Film Forming Resin | 87.72 | 91.26 | — | — |
| Keystone black | Pigment | 5.26 | | — | — |
| Silicon Carbide C 1200W | Filler | 2.63 | | — | — |
| Rheolate 310D | Rheology modifier | 4.39 | 4.56 | — | — |
| Afflair 153 | Pigment | | 0.91 | — | — |
| BYK 333 | Surface additive | | 1.83 | — | — |
| A0156 Si oil | Silicone oil | | 1.44 | — | — |
| TEST | | | | | |
| Visc #4/s | | 25 | 25 | — | — |
| DFT/μm | | 7 | 7 | 7.2/7.8 | 17.82/7.18 |
| Gloss | | 56 | 70 | 56 | 56 |
| Pencil hardness at 20-25° C. | | 6H | 6H | 6H | 6H |
| MEK DR | | 50+ | 50+ | 50+ | 50+ |
| Indent | | Pass | Pass | Pass | Pass |
| Cupping Test | | Pass | Pass | Pass | Pass |

### Example 7—Pre-Neutralized Solvent Borne Coating Formulation

In previous examples the acid rich acrylic resin has been blended with a film forming resin, neutralized, and dispersed into water although the neutralization and dispersion step are not necessary to see the performance advantages.

This example describes the formation of a solvent blend where the acid rich acrylic polymer is blended with a film forming resin selected from the Table 6 and formulated into a coating with pigments slip and flow aids and release aids.

Table 15 describes the formation of an acrylic/silicone polymer coating composition from an acid polymer and a film forming resin.

TABLE 15
Acrylic/Silicone Polymer Coating Composition

| | | Control | Ex. 8a | Ex. 8b | Ex. 8c | Ex. 8d | Ex. 8e |
|---|---|---|---|---|---|---|---|
| Ingredient | Description | (wt. %) | (wt. %) | (wt. %) | (wt. %) | (wt. %) | (wt. %) |
| SP2 | Film Forming | 82.84 | 73.35 | 73.35 | 76.49 | 76.49 | 76.49 |
| | Resin | | | | | | |
| Example 1A | Acid Acrylic | — | 8.42 | 8.42 | 8.72 | 8.72 | 8.72 |
| | Polymer | | | | | | |
| K6435 Black | Pigment | 6.80 | 6.75 | 6.75 | 6.99 | 6.99 | 6.99 |
| AR3122 Al | Pigment | 1.08 | 0.96 | 0.96 | 1.99 | 1.99 | 1.99 |
| flake | | | | | | | |
| Tego 407 | Slip and Flow | 0.44 | 0.39 | 0.39 | 0.40 | 0.40 | 0.40 |
| PMX-0156 | Release Aid | — | — | — | 1.21 | 2.18 | 3.67 |
| PMX 200 350 | Release Aid | — | 0.31 | 0.50 | | | |
| cSt | | | | | | | |
| Dowsil 1-9770 | Release Aid | 0.5 | 0.94 | 1.51 | — | — | — |
| Xylene | Silicone | 1 | 1.26 | 2.03 | — | — | — |
| | cosolvent | | | | | | |
| N-Propyl | Silicone | — | 2.77 | 4.43 | — | — | — |
| Acetate | cosolvent | | | | | | |
| Di-propylene | Solvent | 7.34 | 4.85 | 1.66 | 4.20 | 3.23 | 1.74 |
| glycol mono | | | | | | | |
| methyl ether | | | | | | | |

Table 16 describes the properties of the acrylic/silicone polymer coating, wherein, among the various test results, a “pass” for 0T bend is a beneficial result but not required.

TABLE 16
Properties of Acrylic/Silicone Polymer Coating

| Coating | | Ex. | Ex. | Ex. | Ex. | Ex. |
|---|---|---|---|---|---|---|
| Properties | Control | 8a | 8b | 8c | 8d | 8e |
| DFT (μm) | 10-12 | 10-12 | 10-12 | 10-12 | 10-12 | 10-12 |
| Pencil | 2H | 5H | 5H | 5H | 4H | 5H |
| Hardness | | | | | | |
| at 20-25° C. | | | | | | |
| MEK DR | 50+ | 50+ | 50+ | 50+ | 50+ | 50+ |
| 0T | 1 (fail) | 4 (fail) | 4 (fail) | 5 (pass) | 3 (fail) | 5 (pass) |
| Indent | 1 | 5 | 5 | 5 | 3 | 5 |
| EU steak | 2 | 5 | 5 | 5 | 5 | 5 |
| cycles | | | | | | |
| Staining after | 1 | 3 | 4 | 5 | 4 | 5 |
| steak test | | | | | | |
| BBQ/mustard | 1 | 4 | 5 | 3 | 4 | 5 |
| Release | | | | | | |
| BBQ/Mustard | 1 | 3 | 4 | 5 | 4 | 5 |
| Staining | | | | | | |

Wherein particular examples of this invention have been described above for purposes of illustration, it will be evident to those skilled in the art that numerous variations of the details of the present invention may be made without departing from the invention as defined in the appended claims. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A coating composition, comprising:
an acrylic emulsion comprising particles formed of first and second polymers;
the first polymer polymerized from ethylenically unsaturated monomers including an acid containing monomer;
the second polymer chemically different from the first polymer, the second polymer polymerized from ethylenically unsaturated monomers including a linking monomer;
the first and second polymers having at least one of crosslinking covalent linkages and non-covalent interactions between the acid containing monomer of the first polymer and the linking monomer of the second polymer;
a filler material present in an amount of at least 2 wt. % based on a total weight of the coating composition; and
water.

2. The coating composition of claim 1, wherein the first polymer has a content of acid containing monomers from 10 wt. % to 90 wt. %, based on a total weight of the first polymer.

3. The coating composition of claim 1, comprising a total amount of non-aqueous solvents of 10 wt. % or less, based on the total weight of the coating composition.

4. The coating composition of claim 1, wherein the linking monomer of the second polymer comprises an epoxy functional group.

5. The coating composition of claim 1, further comprising a melamine-based crosslinker.

6. The coating composition of claim 1, wherein at least one of:
the first and second polymers are polymerized in the absence of chain transfer agents; and
the coating composition comprises a total content of per- and polyfluoroalkyl substances (PFAS) of less than 1 ppm, based on a total weight of the coating composition, as determined by liquid chromatography-tandem mass spectrometry (LC-MS/MS).

7. (canceled)

8. A method of coating a substrate with a coating composition, comprising:
applying, to the surface of the substrate, the coating composition of claim 1; and
curing the coating composition to form a coating.

9. An article coated according to the method of claim 8, the article selected from an article of cookware, an article of bakeware, and a cooking appliance; and
wherein the coating comprises at least one of the following characteristics:
a dry film thickness (DFT) of at least 10 microns;
a gloss of at least 150 measured at 60° according to ASTM D523 (2018);
a pass result when tested for 0T bend according to ASTM D4145 (2018);
a pencil hardness of at least 5H at 20-25° C. according to ASTM D 3363 (2022); and
a pencil hardness of at least 3H at a temperature of 400° F. (204° C.) according to ASTM D 3363 (2022).

10. (canceled)

11. An acrylic emulsion composition, comprising:
an aqueous medium;
a neutralizing agent; and
emulsion particles comprising:
a film-forming resin comprising a siloxane polymer;
an acrylic polymer polymerized from ethylenically unsaturated monomers comprising an acid containing monomer; and
wherein the film-forming resin is emulsified by the acrylic polymer within the aqueous medium.

12. The emulsion composition of claim 11, wherein the acrylic polymer has a content of acid containing monomers from 20 wt. % to 70 wt. %, based on a total weight of the acrylic polymer.

13. The emulsion composition of claim 11, wherein the acrylic polymer is present in an amount of from 2 to 15 wt. %, based on a total weight of the acrylic polymer and the film-forming resin; and
wherein the acrylic polymer may comprise an average particle size (D50) from 0.01 to 10 microns as determined by dynamic light scattering according to ISO 13320-1 based on volume.

14. (canceled)

15. The emulsion composition of claim 11, wherein the film-forming resin comprises a hydrophobic polymer bonded to the siloxane polymer.

16. The emulsion composition of claim of claim 11, wherein the neutralizing agent comprises an amine compound.

17. (canceled)

18. A method of coating a substrate with a coating composition, comprising:
applying, to the surface of the substrate, a coating composition comprising the emulsion composition of claim 12; and
curing the coating composition to form a coating.

19. An article coated according to the method of claim 18, the article selected from an article of cookware, an article of bakeware, and a cooking appliance; and
wherein the coating comprises at least one of the following characteristics:
a dry film thickness (DFT) of at least 7 microns;
a gloss of at least 50 measured at 60° according to ASTM D523 (2018);
a pass result when tested for 0T bend according to ASTM D4145 (2018); and
a pencil hardness of at least 3H at a temperature of 20-25° C. according to ASTM D 3363 (2022).

20. (canceled)

21. A coating composition, comprising:
a solvent medium;
a film-forming resin, the film-forming resin comprising a siloxane polymer; and
an acrylic polymer polymerized from ethylenically unsaturated monomers comprising an acid containing monomer, wherein the ethylenically unsaturated monomers have a content of acid containing monomers from 20 wt. % to 70 wt. %, based on a total weight of the ethylenically unsaturated monomers;
wherein the emulsion comprises a total content of per- and polyfluoroalkyl substances (PFAS) of less than 1 ppm, as determined by liquid chromatography-tandem mass spectrometry (LC-MS/MS).

22. The coating composition of claim 21, further comprising a filler material present in an amount of at least 2 wt. % based on a total weight of the coating composition.

23. The coating composition of claim 21, wherein the acrylic polymer is present in an amount of from 2 to 15 wt. %, based on a total weight of the acrylic polymer and the film-forming resin.

24. (canceled)

25. A method of coating a substrate with a coating composition, comprising:
applying, to the surface of the substrate, the coating composition of claim 21; and
curing the coating composition to form a coating.

26. An article coated according to the method of claim 25, the article selected from an article of cookware, an article of bakeware, and a cooking appliance; and
wherein coating comprises at least one of the following characteristics:
a dry film thickness (DFT) of at least 10 microns;
a pass result when tested for 0T bend according to ASTM D4145 (2018); and
a pencil hardness of at least 4H at a temperature of 20-25° C. according to ASTM D 3363 (2022).

27. (canceled)
